(19) United States
(12) Patent Application Publication
(10) Pub. No.: US 2018/0117888 A1
(43) Pub. Date: May 3, 2018

(54) FLUORINE-CONTAINING COPOLYMER, COMPOSITION, OPTICAL FILM, HARDCOAT FILM, POLARIZING PLATE, AND TOUCH PANEL DISPLAY, AND METHOD FOR PRODUCING FLUORINE-CONTAINING COPOLYMER

(71) Applicant: FUJIFILM Corporation, Tokyo (JP)

(72) Inventors: Reiko FUKAGAWA, Kanagawa (JP); Akio TAMURA, Kanagawa (JP); Taketo OTANI, Kanagawa (JP)

(73) Assignee: FUJIFILM Corporation, Tokyo (JP)

(21) Appl. No.: 15/856,597

(22) Filed: Dec. 28, 2017

Related U.S. Application Data
(63) Continuation of application No. PCT/JP2016/069254, filed on Jun. 29, 2016.

(30) Foreign Application Priority Data
Jun. 30, 2015 (JP) 2015-132077

(51) Int. Cl. B32B 27/30; C08F 218/02; C08J 5/18; C09D 133/16; G02B 5/30; G02B 1/14

(52) U.S. Cl. CPC B32B 27/30; C08F 218/02; G02B 1/14; C09D 133/16; G02B 5/30; C08J 5/18

(57) ABSTRACT

A fluorine-containing copolymer includes: a repeating unit represented by General Formula (I) and a repeating unit represented by General Formula (II), a composition containing the fluorine-containing copolymer, an optical film having a layer formed of the composition, a hardcoat film, a polarizing plate, and a touch panel display, and a method for producing a fluorine-containing copolymer.

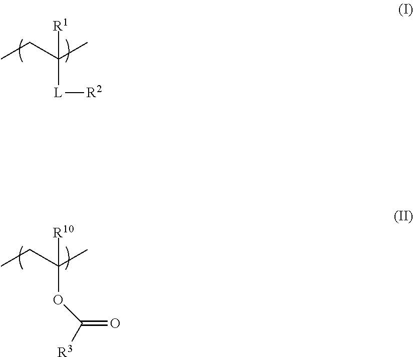

R¹, R¹⁰, and R³ each independently represent a hydrogen atom or an alkyl group having 1 to 20 carbon atoms, R² represents an alkyl group having 1 to 20 carbon atoms in which at least one carbon atom has a fluorine atom as a substituent, and L represents a divalent linking group constituted of at least one group selected from the group consisting of —O—, —(C═O)O—, —O(C═O)—, divalent chain-like groups, and divalent aliphatic cyclic groups.

### CROSS REFERENCE TO RELATED APPLICATIONS

This is a continuation of International Application No. PCT/JP2016/069254 filed on Mar. 14, 2016, and claims priority from Japanese Patent Application No. 2015-132077 filed on Jun. 30, 2015, the entire disclosures of which are incorporated herein by reference.

### BACKGROUND OF THE INVENTION

### 1. Field of the Invention

The present invention relates to a fluorine-containing copolymer, a composition, an optical film, a hardcoat film, a polarizing plate, and a touch panel display, and a method for producing a fluorine-containing copolymer.

### 2. Description of the Related Art

Image display devices such as display devices for which cathode-ray tubes (CRT) are used, plasma display panels (PDP), electroluminescence displays (ELD), vacuum fluorescent displays (VFD), field emission displays (FED), and liquid crystal displays (LCD), a hardcoat film having a hardcoat layer on a support is preferably disposed on a display surface in order to prevent scratches on the display surface.

Recently, in response to the diversification of image display devices such as touch panel uses, a demand for laminating (recoating) other functional layers on hardcoat layers has intensified, and there has been a demand for hardcoat layers that are easily laminated with other layers, that is, are excellent in terms of the lamination property (recoatability) with other layers. In a case in which the surface of a hardcoat layer is not hydrophilic and does not have favorable wettability at the time of recoating a layer on the hardcoat layer, the uniformity of the upper layer (surface smoothness) is impaired so as to cause cissing-like troubles or uneven coating thicknesses. However, on the other hand, generally, leveling agents such as fluorine-containing polymers are added to hardcoat layers in order to enhance the uniformity of coated films on the hardcoat layers, and thus the surfaces of hardcoat layers are hydrophobilized due to the hydrophobicity of the leveling agents. Therefore, the surface properties and recoatability of hardcoat layers have a trade-off relationship.

For example, JP2000-102727A describes the use of a specific fluorine-based surfactant for the purpose of uniform coatability with respect to base materials during coating or recoatability after coating.

In addition, JP2005-248116A describes a fluorine-containing polymer capable of reversibly changing the surfaces of coatings from hydrophobic to hydrophilic by external environments.

### SUMMARY OF THE INVENTION

However, according to studies by the present inventors, it was found that, in a case in which a coated film is formed using the fluorine-containing polymer described in JP2000-102727A or JP2005-248116A as an additive, the contact angle of water on the film surface is large, cissing occurs at the time of coating upper layers, and the satisfaction level of both the uniformity and recoatability of coated films is not satisfactory.

In consideration of the above-described problem, an object of the present invention, that is, a problem to be solved by the present invention is to provide a fluorine-containing copolymer capable of forming films that are excellent in terms of surface properties and a lamination property with other layers, a composition containing the fluorine-containing copolymer, an optical film having a layer formed of the composition, a hardcoat film, a polarizing plate, and a touch panel display, and a method for producing a fluorine-containing copolymer.

As a result of intensive studies for solving the above-described problem, the present inventors found that the problem can be solved by the following means.

A fluorine-containing copolymer of the present invention became capable of forming a hydrophilic surface after, particularly, a saponification treatment by combining a vinyl ester structure represented by General Formula (II) (different from an acrylic acid ester structure) into the copolymer. Regarding the hydrophilization mechanism, it is considered that, for example, an acetyl group in vinyl acetate is converted to an OH group by a saponification treatment using an alkali, thereby forming a hydrophilic surface. As structures that are hydrophilized by saponification treatments, ester groups (*—O(C═O) type; * represents a linking portion to a main chain) that are directly bonded to main chains like vinyl esters in the present invention are preferred, but ester groups (*—(C═O)O— type; represents a linking portion to a main chain) such as acrylate are not considered as those structures. Therefore, it was found that, particularly in lamination coating, coating is possible without causing cissing even to underlayers for which coating is difficult in the related art due to the occurrence of cissing.

In recent years, as the multifunctionalization of hardcoat layers, a demand for laminating other layers suitable for uses, for example, an antistatic layer, a high-refractive index layer, a low-refractive index layer, and a phase difference layer on the surface of a hardcoat layer has intensified, and, regarding this demand, it was found that the use of the fluorine-containing copolymer of the present invention forms sufficiently hydrophilic surfaces, and thus highly adhesive lamination is possible without causing cissing. In addition, it was found that, even in a case in which a surface panel and a display module are attached to each other by filling a space therebetween with an optical resin (OCR) in touch panel uses, the use of the fluorine-containing copolymer of the present invention as a composition for forming a hardcoat layer on the surface of a display module enables the improvement of the wettability and adhesiveness of OCR.

<1> A fluorine-containing copolymer comprising: a repeating unit represented by General Formula (I); and a repeating unit represented by General Formula (II).

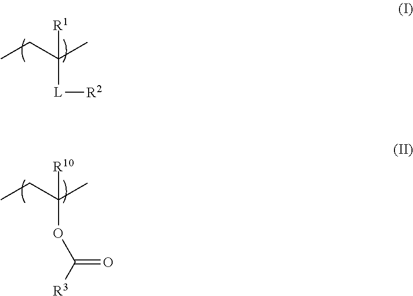

In General Formulae (I) and (II), R¹, R¹⁰, and R³ each independently represent a hydrogen atom or an alkyl group having 1 to 20 carbon atoms, R² represents an alkyl group having 1 to 20 carbon atoms in which at least one carbon atom has a fluorine atom as a substituent, and L represents a divalent linking group constituted of at least one group selected from the group consisting of —O—, —(C═O)O—, —O(C═O)—, divalent chain-like groups, and divalent aliphatic cyclic groups.

<2> The fluorine-containing copolymer according to <1>, in which the fluorine-containing copolymer has at least a first segment and a second segment, the first segment includes 30% by mass or more of the repeating unit represented by General Formula (I) and includes 0% to 20% by mass of the repeating unit represented by General Formula (II) with respect to all repeating units included in the first segment, and the second segment includes 30% by mass or more of the repeating unit represented by General Formula (II) and includes 0% to 3% by mass of the repeating unit represented by General Formula (I) with respect to all repeating units included in the second segment.

<3> The fluorine-containing copolymer according to <2>, in which the fluorine-containing copolymer is a polymer or a block copolymer having a branched structure.

<4> The fluorine-containing copolymer according to any one of <1> to <3>, in which the repeating unit represented by General Formula (I) is represented by General Formula (III).

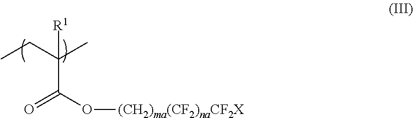

In General Formula (III), R¹ represents a hydrogen atom or an alkyl group having 1 to 20 carbon atoms, ma and na each independently represent an integer of 1 to 10, and X represents a hydrogen atom or a fluorine atom.

<5> The fluorine-containing copolymer according to <4>, in which ma represents 1 or 2, and na represents an integer of 1 to 6.

<6> The fluorine-containing copolymer according to any one of <1> to <5>, in which R³ is a methyl group, an ethyl group, a propyl group, a t-butyl group, or an n-butyl group.

<7> The fluorine-containing copolymer according to any one of <1> to <6>, further comprising: a repeating unit represented by General Formula (IV).

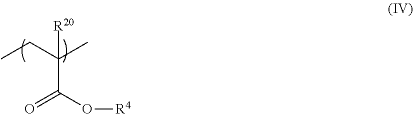

In General Formula (IV), R²⁰ represents a hydrogen atom or an alkyl group having 1 to 20 carbon atoms, and R⁴ represents a chain-like or cyclic alkyl group, an alkenyl group, or a polyoxyalkylene group which may have a substituent.

<8> The fluorine-containing copolymer according to <7>, in which the repeating unit represented by General Formula (IV) is represented by General Formula (V).

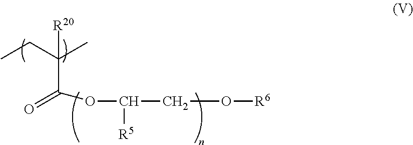

In General Formula (V), R²⁰ represents a hydrogen atom or an alkyl group having 1 to 20 carbon atoms, and R⁵ and R⁶ each independently represent a hydrogen atom or a methyl group. n represents an integer of 1 to 100.

<9> A composition comprising: the fluorine-containing copolymer according to any one of <1> to <8>.

<10> The composition according to <9>, further comprising: a curable compound.

<11> An optical film comprising: a layer formed of the composition according to <9> or <10>.

<12> A hardcoat film comprising: a layer formed of the composition according to <9> or <10>.

<13> A polarizing plate comprising: a layer formed of the composition according to <9> or <10>.

<14> A touch panel display comprising: a liquid crystal cell; the polarizing plate according to <13> on a viewer side of the liquid crystal cell; and OCA or OCR on a surface of the polarizing plate opposite to the liquid crystal cell.

<15> A method for producing a fluorine-containing copolymer having at least a first segment and a second segment, the first segment including 30% by mass or more of a repeating unit represented by General Formula (I) and including 0% to 20% by mass of a repeating unit represented by General Formula (II) with respect to all repeating units included in the first segment, and the second segment including 30% by mass or more of the repeating unit represented by General Formula (II) and including 0% to 3% by mass of the repeating unit represented by General Formula (I) with respect to all repeating units included in the second segment, the method including any one of following steps (i) to (iii):

(i): a step of respectively synthesizing a first polymer including 30% by mass or more of the repeating unit represented by General Formula (I) and a second polymer including 30% by mass or more of the repeating unit represented by General Formula (II) and subsequently bonding the first polymer and the second polymer.

(ii): a step of synthesizing the first polymer including 30% by mass or more of the repeating unit represented by General Formula (I) and subsequently reacting a compound represented by General Formula (II-M) with the first polymer.

(iii): a step of synthesizing the second polymer including 30% by mass or more of the repeating unit represented by General Formula (II) and subsequently reacting a compound represented by General Formula (I-M) with the second polymer.

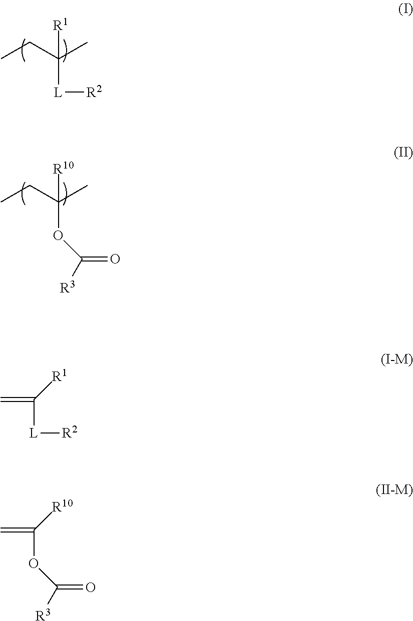

In General Formulae (I), (II), (I-M), and (II-M), R¹, R¹⁰, and R³ each independently represent a hydrogen atom or an alkyl group having 1 to 20 carbon atoms, R² represents an alkyl group having 1 to 20 carbon atoms in which at least one carbon atom has a fluorine atom as a substituent, and L represents a divalent linking group constituted of at least one group selected from the group consisting of —O—, —(C═O)O—, —O(C═O)—, divalent chain-like groups, and divalent aliphatic cyclic groups.

According to the present invention, it is possible to provide a fluorine-containing copolymer capable of forming films that are excellent in terms of surface properties and a lamination property with other layers, a composition containing the fluorine-containing copolymer, an optical film having a layer formed of the composition, a hardcoat film, a polarizing plate, and a touch panel display, and a method for producing a fluorine-containing copolymer.

### DESCRIPTION OF THE PREFERRED EMBODIMENTS

Hereinafter, the present invention will be described in detail.

Meanwhile, in the present specification, numerical ranges expressed using “to” include numerical values before and after “to” as the upper limit value and the lower limit value.

In the present specification, “(meth)acrylic groups” refer to “acrylic groups or/and methacrylic groups”. What has been described above is also true to (meth)acrylate, (meth)acrylamide, (meth)acryloyl groups, and the like.

[Fluorine-Containing Copolymer]

A fluorine-containing copolymer of the present invention is a fluorine-containing copolymer including a repeating unit represented by General Formula (I) and a repeating unit represented by General Formula (II).

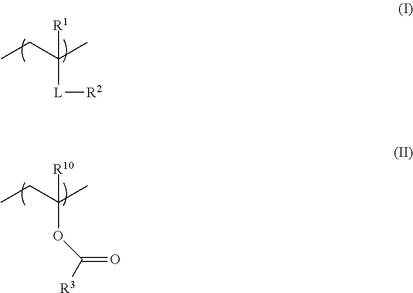

In General Formulae (I) and (II), R¹, R¹⁰, and R³ each independently represent a hydrogen atom or an alkyl group having 1 to 20 carbon atoms, R² represents an alkyl group having 1 to 20 carbon atoms in which at least one carbon atom has a fluorine atom as a substituent, and L represents a divalent linking group constituted of at least one group selected from the group consisting of —O—, —(C═O)O—, —O(C═O)—, divalent chain-like groups, and divalent aliphatic cyclic groups.

General Formula (I) represents a repeating unit derived from a fluoro aliphatic group-containing monomer.

R¹ in General Formulae (I) represents a hydrogen atom or an alkyl group having 1 to 20 carbon atoms, is preferably a hydrogen atom or an alkyl group having 1 to 10 carbon atoms, more preferably a hydrogen atom or an alkyl group having 1 to 4 carbon atoms, and still more preferably a hydrogen atom or a methyl group.

R² in General Formulae (I) represents an alkyl group having 1 to 20 carbon atoms (fluoroalkyl group) in which at least one carbon atom has a fluorine atom as a substituent, is preferably a fluoroalkyl group having 1 to 12 carbon atoms and more preferably a fluoroalkyl group having 2 to 10 carbon atoms. In addition, the number of fluorine atoms is preferably 1 to 25, more preferably 3 to 20, and most preferably 8 to 15.

L in General Formula (I) represents a divalent linking group constituted of at least one group selected from the group consisting of —O—, —(C═O)O—, —O(C═O)—, divalent chain-like groups, and divalent aliphatic cyclic groups. Meanwhile, —(C═O)O— indicates that a carbon atom to which R¹ is bonded and C═O are bonded to each other, and R² and O are bonded to each other, and —O(C═O)— indicates that a carbon atom to which R¹ is bonded and O are bonded to each other, and R² and C═O are bonded to each other.

The divalent chain-like group represented by L is preferably an alkylene group having 1 to 20 carbon atoms and more preferably an alkylene group having 1 to 10 carbon atoms.

The divalent aliphatic cyclic group represented by L is preferably a cycloalkylene group having 3 to 20 carbon atoms and more preferably a cycloalkylene group having 3 to 15 carbon atoms.

L is preferably —(C═O)O— or —O(C═O)— and more preferably —(C═O)O—.

From the viewpoint of the effective formation of hydrophilic surfaces and the radical polymerization property, the repeating unit represented by General Formula (I) is particularly preferably represented by General Formula (III).

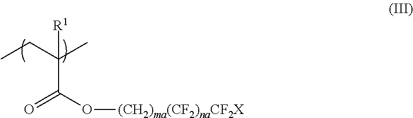

In General Formula (III), R¹ represents a hydrogen atom or an alkyl group having 1 to 20 carbon atoms, ma and na each independently represent an integer of 1 to 10, and X represents a hydrogen atom or a fluorine atom.

R¹ in General Formula (III) is the same as R¹ in General Formula (I), and the preferable range thereof is also identical.

ma and na in General Formula (III) represent an integer of 1 to 10.

From the viewpoint of the effective formation of hydrophilic surfaces and ease of raw material procurement and production, ma in General Formula (III) is preferably 1 to 8, more preferably 1 to 5, and most preferably 1 or 2. In addition, na is preferably 1 to 8, more preferably 1 to 7, and most preferably 1 to 6.

X in General Formula (III) represents a hydrogen atom or a fluorine atom and preferably represents a fluorine atom,

Next, General Formula (II) will be described.

R¹⁰ in General Formula (II) represents a hydrogen atom or an alkyl group having 1 to 20 carbon atoms, is preferably a hydrogen atom or an alkyl group having 1 to 10 carbon atoms, more preferably a hydrogen atom or an alkyl group having 1 to 4 carbon atoms, and still more preferably a hydrogen atom.

R³ in General Formula (II) represents a hydrogen atom or an alkyl group having 1 to 20 carbon atoms, is preferably an alkyl group having 1 to 14 carbon atoms and more preferably an alkyl group having 1 to 8 carbon atoms.

Particularly, R³ in General Formula (II) is preferably a methyl group, an ethyl group, a propyl group, a t-butyl group, or an n-butyl group from the viewpoint of responsiveness to external stimuli such as saponification treatments using an alkali.

Meanwhile, R³ has no fluorine atom.

From the viewpoint of the compatibility of hardcoat layers with matrixes (the solubility as coating composition), the fluorine-containing copolymer of the present invention preferably further has a repeating unit represented by General Formula (IV).

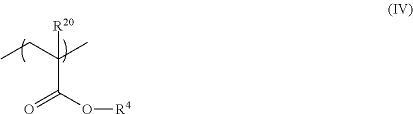

In General Formula (IV), R²⁰ represents a hydrogen atom or an alkyl group having 1 to 20 carbon atoms, and R⁴ represents a chain-like or cyclic alkyl group, an alkenyl group, or a polyoxyalkylene group which may have a substituent.

R²⁰ in General Formula (IV) is the same as R¹ in General Formula (I), and the preferable range thereof is also identical.

R⁴ in General Formula (IV) represents a chain-like or cyclic alkyl group, an alkenyl group, or a polyoxyalkylene group which may have a substituent.

The chain-like alkyl group represented by R⁴ is preferably a linear or branched alkyl group having 1 to 20 carbon atoms and more preferably a linear or branched alkyl group having 1 to 10 carbon atoms.

The cyclic alkyl group represented by R⁴ is preferably a cyclic alkyl group having 3 to 20 carbon atoms and more preferably a cyclic alkyl group having 3 to 12 carbon atoms.

The alkenyl group represented by R⁴ is preferably a linear or branched alkenyl group having 2 to 20 carbon atoms and more preferably a linear or branched alkenyl group having 2 to 10 carbon atoms.

The polyoxyalkylene group represented by R⁴ is preferably a polyoxyalkylene group having 2 to 200 carbon atoms and more preferably a polyoxyalkylene group having 4 to 120 carbon atoms.

R⁴ in General Formula (IV) is particularly preferably a polyoxyalkylene group.

From the viewpoint of the compatibility of hardcoat layers with matrixes (the solubility as coating composition) and the effective formation of hydrophilic surfaces, the repeating unit represented by General Formula (IV) is particularly preferably represented by General Formula (V).

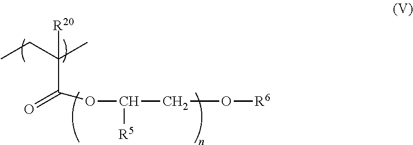

In General Formula (V), R²⁰ represents a hydrogen atom or an alkyl group having 1 to 20 carbon atoms, and R⁵ and R⁶ each independently represent a hydrogen atom or a methyl group. n represents an integer of 1 to 100.

R²⁰ in General Formula (V) is the same as R²⁰ in General Formula (IV), and the preferable range thereof is also identical.

R⁵ in General Formula (V) represents a hydrogen atom or a methyl group and preferably represents a hydrogen atom.

R⁶ in General Formula (V) represents a hydrogen atom or a methyl group and preferably represents a methyl group.

n in General Formula (V) represents an integer of 1 to 100, preferably represents an integer of 1 to 50, more preferably represents an integer of 1 to 45, and most preferably represents an integer of 2 to 40.

In the fluorine-containing copolymer of the present invention, the content of the repeating unit represented by General Formula (I) is preferably 2% to 50% by mass, more preferably 3% to 40% by mass, and still more preferably 3% to 35% by mass of the total mass of the fluorine-containing copolymer.

In the fluorine-containing copolymer of the present invention, the content of the repeating unit represented by General Formula (II) is preferably 50% to 98% by mass, more preferably 50% to 97% by mass, and still more preferably 60% to 96% by mass of the total mass of the fluorine-containing copolymer,

In the fluorine-containing copolymer of the present invention, the content of the repeating unit represented by General Formula (IV) is preferably 0% to 50% by mass, more preferably 1% to 45% by mass, and still more preferably 2% to 40% by mass of the total mass of the fluorine-containing copolymer.

The weight-average molecular weight (Mw) of the fluorine-containing copolymer of the present invention is preferably 1,000 to 50,000, more preferably 1,500 to 40,000, and still more preferably 2,000 to 30,000.

The number-average molecular weight (Mn) of the fluorine-containing copolymer of the present invention is preferably 500 to 40,000, more preferably 600 to 35,000, and still more preferably 600 to 30,000.

The dispersion degree (Mw/Mn) of the fluorine-containing copolymer of the present invention is preferably 1.00 to 12.00, more preferably 1.00 to 11.00, and still more preferably 1.00 to 10.00.

Meanwhile, the weight-average molecular weight and the number-average molecular weight are values measured by means of gel permeation chromatography (GPC) under the following conditions.

[Eluent] Tetrahydrofuran (THF)

[Instrument name] EcoSEC HLC-8320GPC (manufactured by Tosoh Corporation)

[Column] TSKgel SuperHZM-H, TSKgel SuperHZ4000, TSKgel SuperHZ200 (manufactured by Tosoh Corporation)

[Column temperature] 40° C.

[Flow rate] 0.35 ml/min

The fluorine-containing copolymer of the present invention can be synthesized using well-known methods.

Specific examples of the fluorine-containing copolymer of the present invention will be illustrated, but the present invention is not limited thereto.

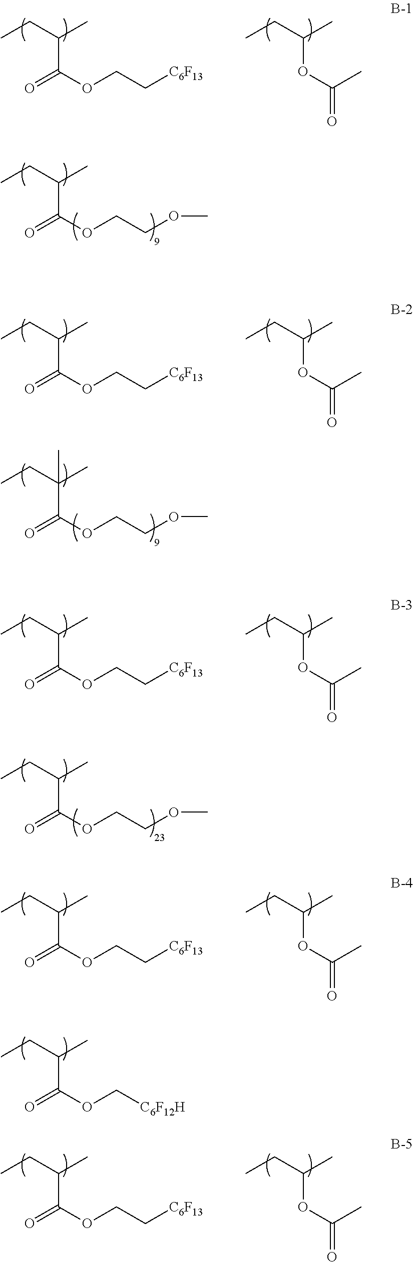

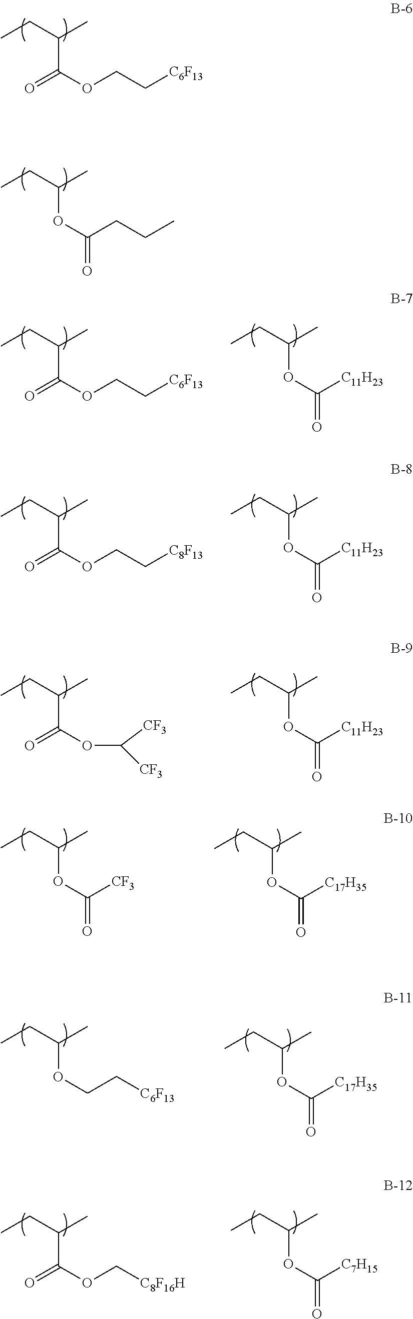

Since a monomer corresponding to General Formula (I) (for example, a fluorine-containing acrylate) and a monomer corresponding to General Formula (II) (for example, vinyl acetate) are different from each other in terms of the radical polymerization reactivity (the monomer corresponding to General Formula (I) polymerizes earlier), in the fluorine-containing copolymer of the present invention, a part rich with the repeating unit represented by General Formula (I) and a part rich with the repeating unit represented by General Formula (II) coexist in a mixed form. It is considered that the above-described gradation provides excellent compatibility of hardcoat layers with matrixes (the solubility as coating composition) and enables effective ensuring of a levelability and recoatability.

Particularly, the fluorine-containing copolymer is preferably a polymer having a first segment and a second segment described below (preferably a polymer or block copolymer having a branched structure) since the above-described effects are more significantly exhibited.

A particularly preferred form of the fluorine-containing copolymer of the present invention will be described below.

It is preferable that the fluorine-containing copolymer of the present invention has at least a first segment and a second segment,
the first segment includes 30% by mass or more of the repeating unit represented by General Formula (I) and includes 0% to 20% by mass of the repeating unit represented by General Formula (II) with respect to all repeating units included in the first segment, and
the second segment includes 30% by mass or more of the repeating unit represented by General Formula (II) and includes 0% to 3% by mass of the repeating unit represented by General Formula (I) with respect to all repeating units included in the second segment.

The first segment is a segment rich with the repeating unit represented by General Formula (I), and the second segment is a segment rich with the repeating unit represented by General Formula (II). The fluorine-containing copolymer preferably has the first segment and the second segment since the function of the repeating unit represented by General Formula (I) (a function of improving surface properties) and the function of the repeating unit represented by General Formula (II) (a function of improving the lamination property with other layers) are sufficiently exhibited respectively.

More specifically, before a saponification treatment is carried out on a film including the fluorine-containing copolymer of the present invention, portions in which R² in General Formula (I) gathers are likely to be segregated on the surface of the film, it is possible to effectively decrease the surface tension of the film, and the uniformity of surface properties is excellent. On the other hand, after the saponification treatment, groups obtained by the conversion of R³ in General Formula (II) to a hydrophilic group are present together and are thus capable of migrating to the surface of the film without being affected by R² in General Formula (I), whereby a film having a low contact angle of water is formed.

The first segment may include the repeating unit represented by General Formula (II), and the content ratio thereof is 20% by mass or less, preferably 15% by mass or less, more preferably 10% by mass or less, and still more preferably 0% by mass with respect to all repeating units included in the first segment.

The second segment may include the repeating unit represented by General Formula (I), and the content ratio thereof is 3% by mass or less, preferably 2% by mass or less, more preferably 1% by mass or less, and still more preferably 0% by mass with respect to all repeating units included in the second segment,

The fluorine-containing copolymer having the first segment and the second segment is preferably a polymer having a branched structure (branched polymer) or a block copolymer.

Examples of a particularly preferred form of the fluorine-containing copolymer include (G1), (G2), (S), and (B).

(G1) Branched polymers in which a branch polymer including the second segment is bonded to a trunk polymer including the first segment.

(G2) branched polymers in which a branch polymer including the first segment is bonded to a trunk polymer including the second segment.

(S) branched polymers in which a polymer (1) including the first segment and a polymer (2) including the second segment elongate from the central point, and

(B) block copolymers in which the first segment and the second segment are coupled together.

<Branched Polymers of (G1) or (G2)>

In the branched polymers of (G1) or (G2), the weight-average molecular weight of the trunk polymer is preferably 1,000 or more and 100,000 or less, more preferably 2,000 or more and 50,000 or less and still more preferably 2,500 or more and 40,000 or less. The weight-average molecular weight of the branch polymer is preferably 500 or more and 20,000 or less, more preferably 800 or more and 15,000 or less and still more preferably 1,000 or more and 13,000 or less.

The content ratio of the branch polymer is preferably 3% by mass or more and 70% by mass or less, more preferably 5% by mass or more and 50% by mass or less, and still more preferably 10% by mass or more and 40% by mass or less with respect to the entire branched polymer.

The trunk polymer in (G1) may include repeating units other than the repeating unit represented by General Formula (I), and the trunk polymer in (G2) may include repeating units other than the repeating unit represented by General Formula (II). The trunk polymer in (G1) or (G2) preferably includes the repeating unit represented by General Formula (IV). The content ratio of the repeating unit represented by General Formula (IV) in the trunk polymer is preferably 0% by mass or more and 50% by mass or less, more preferably 1% by mass or more and 45% by mass or less, and still more preferably 2% by mass or more and 40% by mass or less.

The trunk polymer and the branch polymer preferably have a repeating unit having groups that can be reacted with each other. Examples of combinations of the groups that can be reacted with each other include —N═C═O (isocyanate group) and a hydroxyl group, —N═C═O and a carboxyl group, —N═C═O and an amino group, a carboxyl group and an epoxy group, a carboxyl group and an amino group, and the like. Among these, from the viewpoint of ease of production, —N═C═O and a hydroxyl group and a carboxyl group and an epoxy group are preferred, and the combination of a carboxyl group and an epoxy group is most preferred. Examples of the repeating unit having a carboxyl group include repeating units derived from (meth)acrylic acids, 2-carboxyethyl (meth)acrylates, or the like. Examples of the repeating unit having an epoxy group include repeating units derived from glycidyl (meth)acrylates and the like.

The branch polymer in (G1) may include repeating units other than the repeating unit represented by General Formula (II), and the branch polymer in (G2) may include repeating units other than the repeating unit represented by General Formula (I). Examples of these repeating units include the repeating unit represented by General Formula (IV), repeating units derived from (meth)acrylic acid esters, and the like, and the content ratio thereof is preferably 0% by mass or more and 50% by mass or less, more preferably 1% by mass or more and 45% by mass or less, and still more preferably 2% by mass or more and 40% by mass or less with respect to the entire branch polymer.

Examples of a method for introducing a group capable of reacting with the trunk polymer into a terminal include a method in which the trunk polymer is synthesized and then a modification reaction is caused at a terminal, a method in which the trunk polymer is synthesized using an initiator modified in advance, and a method in which a functional group is introduced into a terminal using a chain transfer agent. Among these, from the viewpoint of ease of production, the use of a chain transfer agent is preferred. Examples of the chain transfer agent include mercaptoethanol, mercaptopropanol, mercaptobutanol, mercaptopentanol, mercaptopropionic acid, mercaptobutanoic acid, mercaptopentanoic acid, and the like. Among these, mercaptopropionic acid and mercaptoethanol are preferred.

The branched polymers of (G1) or (G2) can be synthesized using well-known methods, and, for example, it is possible to refer to the description in pp. 372 to 374 of “Basic Polymer Sciences” by The Society of Polymer Science, Japan (Vol. 1, published Jul. 1, 2006).

<Branched Polymers of (S)>

In the branched polymers of (S), a compound forming the central point preferably has a plurality of groups capable of reacting with a polymer (1) including the first segment and a polymer (2) including the second segment in the molecule, and examples thereof include polyfunctional isocyanate compounds, polyfunctional amine compounds, polyfunctional epoxy compounds, and polyfunctional alcohol compounds. Particularly, polyethyleneimine and epoxy group-containing acrylic polymers are preferred. The weight-average molecular weight of the compound forming the central point is preferably 100 or more and 15,000 or less, more preferably 200 or more and 9,000 or less, and still more preferably 500 or more and 3,000 or less.

The weight-average molecular weights of the polymer (1) and the polymer (2) are respectively preferably 500 or more and 20,000 or less, more preferably 800 or more and 15,000 or less, and still more preferably 1,000 or more and 13,000 or less.

The content ratios of the polymer (1) and the polymer (2) in the branched polymers of (S) are respectively preferably 10% by mass or more and 80% by mass or less, more preferably 15% by mass or more and 70% by mass or less, and still more preferably 20% by mass or more and 75% by mass or less with respect to the entire brandied polymer.

The polymer (1) may include repeating units other than the repeating unit represented by General Formula (I), and the polymer (2) may include repeating units other than the repeating unit represented by General Formula (II). For example, the polymer (1) or the polymer (2) may include the repeating unit represented by General Formula (IV), repeating units derived from (meth)acrylic acid esters, or the like. The content ratio of these repeating units in the polymer (1) or the polymer (2) is preferably 0% by mass or more and 50% by mass or less, more preferably 1% by mass or more and 45% by mass or less, and still more preferably 2% by mass or more and 40% by mass or less.

The polymer (1) and the polymer (2) preferably have a group capable of reacting with a compound forming the central point at a terminal. A method for introducing the group capable of reacting with the compound forming the central point into the terminal is the same as the method described in the section of the branched polymers of (G1) or (G2).

The compound forming the central point and the branch polymer preferably have groups that can be reacted with each other. Examples of combinations of the groups that can be reacted with each other include —N═C═O and a hydroxyl group, N═C═O and a carboxyl group, —N═C═O and an amino group, a carboxyl group and an epoxy group, a carboxyl group and an amino group, and the like. Among these, from the viewpoint of ease of production, a combination of a carboxyl group and an epoxy group and a carboxyl group and an amino group are preferred, and the combination of a carboxyl group and an amino group is most preferred. Examples of the repeating unit having a carboxyl group include repeating units derived from (meth)acrylic acids, 2-carboxyethyl (meth)acrylates, and the like. Examples of the repeating unit having an epoxy group include repeating units derived from glycidyl (meth)acrylates and the like. Examples of the repeating unit having an amino group include N-t-butyaminoethyl (meth)acrylate. Examples of the central point having an epoxy group include MA-PROOF series. Examples of the central point having —N═C═O include TAKENATE series (manufactured by Mitsui Chemicals, Inc.). Examples of the central point having an amino group include polyethyleneimine.

The branched polymers of (S) can be synthesized using well-known methods, and, for example, it is possible to refer to the description in pp. 372 to 374 of “Basic Polymer Sciences” by The Society of Polymer Science, Japan (Vol. 1, published Jul. 1, 2006).

<Block Copolymers of (B)>

The block copolymers of (B) may be diblock copolymers in which two blocks are bonded together or block copolymers in which three or more blocks are coupled together.

The block copolymers of (B) are preferably copolymers in which a polymer (b1) forming the first segment and a polymer (b2) forming the second segment are coupled together directly or through a linking chain.

The weight-average molecular weight of the polymer (b1) forming the first segment is preferably 800 or more and 30,000 or less, more preferably 1,000 or more and 25,000 or less and still more preferably 2,000 or more and 20,000 or less.

The weight-average molecular weight of the polymer (b2) forming the second segment is preferably 800 or more and 25,000 or less, more preferably 1,000 or more and 20,000 or less and still more preferably 2,000 or more and 10,000 or less.

The polymer (b1) may include repeating units other than the repeating unit represented by General Formula (I), and the polymer (b2) may include repeating units other than the repeating unit represented by General Formula (II). For example, the polymer (b1) or the polymer (b2) may include the repeating unit represented by General Formula (IV), repeating units derived from (meth)acrylic acids, repeating units derived from (meth)acrylic acid esters, or the like. The content ratio of these repeating units in the polymer (b1) or the polymer (b2) is preferably 0% by mass or more and 50% by mass or less, more preferably 1% by mass or more and 45% by mass or less, and still more preferably 2% by mass or more and 40% by mass or less.

The block copolymers of (B) can be synthesized using well-known methods, and, for example, it is possible to refer to the description in pp. 363 to 365 of “Basic Polymer Sciences” by The Society of Polymer Science, Japan (Vol. 1, published Jul. 1, 2006).

The content ratio of fluorine in the fluorine-containing copolymer is preferably 5% by mass or more and 90% by mass or less and more preferably 10% by mass or more and 80% by mass or less. The content ratio of fluorine is defined using the following expression.

The content ratio of fluorine=100×the mass of fluorine atoms in the fluorine-containing copolymer/the mass of fluorine-containing copolymer

[Method For Producing Fluorine-Containing Copolymer]

A method for producing a fluorine-containing copolymer of the present invention is
a method for producing a fluorine-containing copolymer having at least the first segment and the second segment,
the first segment including 30% by mass or more of a repeating unit represented by General Formula (I) and including 0% to 20% by mass of a repealing unit represented by General Formula (II) with respect to all repeating units included in the first segment, and
the second segment including 30% by mass or more of the repeating unit represented by General Formula (II) and including 0% to 3% by mass of the repeating unit represented by General Formula (I) with respect to all repeating units included in the second segment,
the method including any one of following steps (i) to (iii):
(i): A step of respectively synthesizing a first polymer including 30% by mass or more of the repeating unit represented by General Formula (I) and a second polymer including 30% by mass or more of the repeating unit represented by General Formula (II) and subsequently bonding the first polymer and the second polymer.
(ii): A step of synthesizing the first polymer including 30% by mass or more of the repeating unit represented by General Formula (1) and subsequently reacting a compound represented by General Formula (II-M) with the first polymer.
(iii): A step of synthesizing the second polymer including 30% by mass or more of the repeating unit represented by General Formula (II) and subsequently reacting a compound represented by General Formula (I-M) with the second polymer.

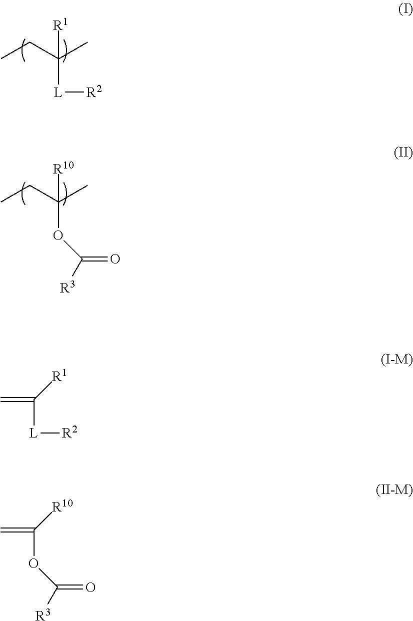

In General Formulae (I), (II), (I-M), and (II-M), R¹, R¹⁰, and R³ each independently represent a hydrogen atom or an alkyl group having 1 to 20 carbon atoms, R² represents an alkyl group having 1 to 20 carbon atoms in which at least one carbon atom has a fluorine atom as a substituent, and L represents a divalent linking group constituted of at least one group selected from the group consisting of —O—, —(C═O)O—, —O(C═O)—, divalent chain-like groups, and divalent aliphatic cyclic groups.

The description of General Formulae (I) and (II) is as described above. The preferable ranges of individual reference signs in General Formulae (I-M) and (II-M) are respectively the same as those of the respective reference signs in General Formulae (I) and (II).

The production method including the step (i) is preferred as the method for producing the branched polymers of (G1) or (G2) and the branched polymers of (S).

The production method including the step (ii) or (iii) is preferred as the method for producing the block copolymers of (B).

[Composition]

Next, a composition containing the fluorine-containing copolymer of the present invention will be described.

A composition of the present invention may contain components other than the fluorine-containing copolymer and preferably contains a compound for forming films and a solvent in addition to the fluorine-containing copolymer. Particularly, in the case of containing a curable compound as the compound for forming a film the composition can be used as a composition for forming a hardcoat layer (coating solution).

In a case in which the total solid contents (all components except for the solvent) of the composition for forming a hardcoat layer in the present invention are set to 100% by mass, from the viewpoint of the satisfaction of both the levelability and the recoatability, the content of the fluorine-containing copolymer of the present invention is preferably 0.01% to 0.2% by mass, more preferably 0.01% to 0.1% by mass, and still more preferably 0.01% to 0.05% by mass. Particularly, in a case in which the form of the fluorine-containing copolymer of the present invention is the branched polymer of (G1), (G2), or (S) or the block copolymer of (B), it becomes possible to form films that are superior in terms of the surface properties and the lamination property with other layers to films formed using different forms of the fluorine-containing copolymer. Therefore, in a case in which the fluorine-containing copolymer of the present invention is the branched polymer of (G1), (G2), or (S) or the block copolymer of (B), compared with cases of using different forms of the fluorine-containing copolymer, it is possible to obtain the same effects with a smaller amount of the fluorine-containing copolymer added (the content of the fluorine-containing copolymer in the composition for forming films). Specifically, in a case in which the total solid contents (all components except for the solvent) of the composition for forming a hardcoat layer in the present invention are set to 100% by mass, it is possible to suppress the content ratio of the fluorine-containing copolymer of the present invention to 0.01% to 0.04% by mass (more preferably 0.01% to 0.03% by mass).

The composition for forming a hardcoat layer in the present invention preferably includes the fluorine-containing copolymer and, furthermore,
(b) a compound having three or more ethylenic unsaturated double bond groups in the molecule,
(c) a compound having one or more epoxy groups in the molecule.
(d) inorganic fine particles having a reactivity with an epoxy group or an ethylenic unsaturated double bond group, and
(e) an ultraviolet absorbent, and
(c) is more preferably a compound having one alicyclic epoxy group and one ethylenic unsaturated double bond group in the molecule and having a molecular weight of 300 or less.

<<(b) Compound Having Three or More Ethylenic Unsaturated Double Bond Groups in Molecule>>

The composition for forming a hardcoat layer of the present invention preferably includes a compound having three or more ethylenic unsaturated double bond groups in the molecule (also referred to as the compound (b)).

Examples of the ethylenic unsaturated double bond group include polymerizable functional groups such as a (meth)acryloyl group, a vinyl group, a styryl group, and an allyl group, and, among these, a (meth)acryloyl group and —C(O)OCH═C₂ is preferred, and a (meth)acryloyl group is particularly preferred. In a case in which the composition has the ethylenic unsaturated double bond group, it is possible to maintain high hardness and also impart humid and heat resistance. Furthermore, in a case in which the composition has three or more ethylenic unsaturated double bond groups in the molecule, higher hardness can be developed.

Examples of the compound (b) include esters of a polyhydric alcohol and a (meth)acrylic acid, vinyl benzene and derivatives thereof, vinyl sulfone, (meth)acrylamide, and the like. Among these, from the viewpoint of hardness, compounds having three or more (meth)acryloyl groups are preferred, and examples thereof include acrylate-based compounds forming high-hardness cured substances that are widely used in the present industry. Examples of the above-described compounds include esters of a polyhydric alcohol and a (meth)acrylic acid {for example, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric tri(meth)acrylate, trimethylolethane tri(meth)acrylate, ditrimethylolpropane tetra(meth)acrylate, dipentaetythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, caprolactone-modified tris(acryloyloxyethyl) isocyanurate, and the like.

Examples of the specific compounds of polyfunctional acrylate-based compounds having three or more (meth)acryloyl groups include KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60, and KAYARAD GPO-303 manufactured by Nippon Kayaku Co., Ltd. and esterified substances of a polyol and a (meth)acrylic acid such as #400 and V#36095D manufactured by Osaka Organic Chemical Industry Ltd. In addition, it is also possible to preferably use ultraviolet UV-1400B, ultraviolet UV-1700B, ultraviolet UV-6300B, ultraviolet UV-7550B, ultraviolet UV-7600B, ultraviolet UV-7605B, ultraviolet UV-7610B, ultraviolet UV-7620EA, ultraviolet UV-763013, ultraviolet UV-7640B, ultraviolet UV-6630B, ultraviolet UV-7000B, ultraviolet UV-7510B, ultraviolet UV-7461TE, ultraviolet UV-3000B, ultraviolet UV-3200B, ultraviolet UV-3210EA, ultraviolet UV-3310EA, ultraviolet UV-3310B, ultraviolet UV-3500BA, ultraviolet UV-3520TL, ultraviolet UV-3700B, ultraviolet UV-6100B, ultraviolet UV-6640B, ultraviolet UV-2000B, ultraviolet UV-2010B, ultraviolet UV-2250EA, or ultraviolet UV-27503 (manufactured by Nippon Synthetic Chemical Industry Co., Ltd.), UL-503 LN (manufactured by Kyoeisha Chemical Co., Ltd.), UNIDIC 17-806, UNIDIC 17-813, UNIDIC V-4030, or UNIDIC V-4000BA (manufactured by DIC Corporation), EB-1290K, EB-220, EB-5129, BE-1830, or EB-4358 (manufactured by Daicel-UCB Company), HI-CORP AU-2010 or HI-COAP AU-2020 (manufactured by Tokushiki Co., Ltd.), tri- or higher-functional urethane acrylate compounds such as ARONIX M-1960 (manufactured by TOAGOSEI CO., LTD.), ART-RESIN UN-3320HA, UN-3320HC, UN-332014S, UN-904, and HDP-4T, tri- or higher-functional polyester compounds such as ARONIX M-8100, M-8030, and M-9050 (manufactured by TOAGOSEI CO., LTD), and KBM-8307 (Daice-Allnex Ltd.), or the like.

In addition, the compound (b) may be constituted of a single compound, and it is also possible to use a combination of a plurality of compounds.

In a case in which the total solid contents (all components except for the solvent) of the composition for forming a hardcoat layer in the present invention are set to 100% by mass, the content of the compound (b) is 40% to 80% by mass, but preferably 45% to 75% by mass, and more preferably 50% to 70% by mass. In a case in which the content is 40% by mass or more, it is possible to obtain sufficient hardness.

The ethylenically unsaturated bond group equivalent weight of the compound (b) is preferably 80 to 130. The ethylenically unsaturated bond group equivalent weight refers to a numerical value obtained by dividing the molecular weight of the compound (b) by the number of ethylenically unsaturated bond groups.

The ethylenically unsaturated bond group equivalent weight of the compound (b) is 80 to 130, but is more preferably 80 to 110 and still more preferably 80 to 100.

<<Compound Having One or More Epoxy Groups in Molecule>>

The composition for forming a hardcoat layer of the present invention preferably includes a compound having one or more epoxy groups in the molecule (also referred to as the compound (c)).

The number of epoxy groups in the compound (c) is not particularly limited as long as the number is one or more.

The molecular weight of the compound (c) is preferably 300 or less, more preferably 250 or less, and still more preferably 200 or less. In addition, from the viewpoint of suppressing volatilization during the formation of hardcoat layers, the molecular weight of the compound (c) is preferably 100 or more and more preferably 150 or more.

Meanwhile, in a case in which the epoxy group is an alicyclic epoxy group and has a molecular weight of 300 or less, it is possible to improve the effect of preventing hardness deterioration.

In a case in which the total solid contents of the composition for forming a hardcoat layer in the present invention are set to 100% by mass, the content of the compound (c) is 10% to 40% by mass, but preferably 12% to 35% by mass, and more preferably 15% to 25% by mass. In a case in which the content is 10% by mass or more, the smoothness-improving effect is excellent, and the surface properties of hardcoat layers become favorable. Meanwhile, in a case in which the content is 40% by mass or less, hardness improves.

The compound (c) preferably further has an ethylenic unsaturated double bond group. The ethylenic unsaturated double bond group is not particularly limited, examples thereof include a (meth)acryloyl group, a vinyl group, a styryl group, an allyl group, and the like, and, among these, a (meth)acryloyl group and —C(O)OCH═CH2 are preferred, and a (meth)acryloyl group is particularly preferred.

In a case in which the compound (c) has the ethylenic unsaturated double bond group, the bonding force to the compound (b) is imparted, and thus it is possible to prevent hardness deterioration and suppress bleeding during moisture-heat permanence.

Specific compounds of the compound (c) are not particularly limited as long as the compounds have one or more alicyclic epoxy groups in the molecule, and it is possible to use bicyclohexyl diepoxide; 3,4,3′,4′-diepoxybicyclohexyl, tetra(3,4-epoxycyclohexylmethyl) butanetetracarboxylate-modified ε-caprolactone, the compounds described in paragraph [0015] of JP1998-17614A (JP-H10-17614A) or represented by General Formula (1A) or (1B), 1,2-epoxy-4-vinylcyclohexane, and the like. Among these, the compounds represented by General Formula (1A) or (1B) are more preferred, and the compounds represented by General Formula (1A) having a low molecular weight are still more preferred. Meanwhile, as the compounds represented by General Formula (1A), isomers thereof are also preferred.

The use of these compounds improves the smoothness and enables the maintenance of high hardness.

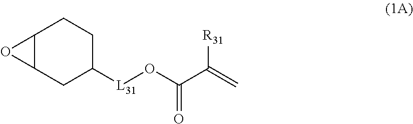

In General Formula (1A), R₃₁ represents a hydrogen atom or a methyl group, and L₃₁ represents a divalent aliphatic hydrocarbon group having 1 to 6 carbon atoms.

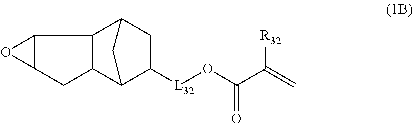

In General Formula (1B), R₃₂ represents a hydrogen atom or a methyl group, and L₃₂ represents a divalent aliphatic hydrocarbon group having 1 to 6 carbon atoms.

In the divalent aliphatic hydrocarbon groups as L³¹ in General Formula (1A) and L³² in General Formula (1B), the numbers of carbon atoms are 1 to 6, more preferably 1 to 3, and still more preferably 1, respectively. The divalent aliphatic hydrocarbon group is preferably a linear, branched, or cyclic alkylene group, more preferably a linear or branched alkylene group, and still more preferably a linear alkylene group.

In the divalent aliphatic hydrocarbon group as L₂ in General Formula (1A) and General Formula (1B), the number of carbon atoms is 1 to 6, more preferably 1 to 3, and still more preferably 1, respectively. The divalent aliphatic hydrocarbon group is preferably a linear, branched, or cyclic alkylene group, more preferably a linear or branched alkylene group, and still more preferably a linear alkylene group.

<<Inorganic Fine Particles>>

The composition for forming a hardcoat layer of the present invention preferably includes inorganic fine particles having a reactivity with an epoxy group or an ethylenic unsaturated double bond group (also referred to as the inorganic fine particles (d)).

The addition of the inorganic fine particles (d) enables the enhancement of the hydrophilicity of cured layers and thus enables a decrease in contact angles. In addition, the addition of the inorganic fine particles enables a decrease in the cure shrinkage amount of cured layers and thus enables a decrease in film curling. Furthermore, the use of the inorganic fine particles having a reactivity with an epoxy group or an ethylenic unsaturated double bond group enables the improvement of pencil hardness. Examples of the inorganic fine particles include silica particles, titanium dioxide particles, zirconium oxide particles, aluminum oxide particles, and the like. Among these, silica particles are preferred.

Generally, inorganic fine particles have low affinity to organic components such as polyfunctional vinyl monomers, and thus, in the case of being simply mixed, there are cases in which aggregates are formed or cured layers that have cured are likely to crack. In order to enhance the affinity between the inorganic fine particles and organic components, the surfaces of the inorganic fine particles are treated using a surface modifier including an organic segment.

The surface modifier preferably has a functional group that forms bonds with the inorganic fine particles or can be adsorbed onto the inorganic fine particles and a functional group having high affinity to organic components in the same molecule. The surface modifier having a functional group that can be bonded or adsorbed onto the inorganic fine particles is preferably a metal alkoxide surface modifier such as silane, aluminum, titanium, or zirconium or a surface modifier having an anionic group such as a phosphoric acid group, a sulfuric acid group, a sulfonic acid group, or a carboxylic acid group. Furthermore, the functional group having high affinity to organic components may be a functional group that is simply adjusted to be hydrophilic or hydrophobic according to organic components, but is preferably a functional group capable of forming a chemical bond with organic components, and particularly preferably an ethylenic unsaturated double bond group or an open-ring polymerizable group.

In the present invention, a preferred surface modifier for the inorganic fine particles is a curable resin having a metal alkoxide or an anionic group and an ethylenic unsaturated double bond group or an open-ring polymerizable group in the same molecule. In a case in which the functional group is chemically bonded to organic components, the crosslinking density of hardcoat layers increases, and it is possible to increase pencil hardness.

Typical examples of these surface modifiers include unsaturated double bond-containing coupling agents, phosphoric acid group-containing curable resins, sulfuric acid group-containing organic curable resins, carboxylic acid group-containing organic curable resins, and the like described below.
S-1 H₂C═C(X)COOC₃H₆Si(OCH₃)₃
S-2 H₂C═C(X)COOC₂H₄OTi(OC₂H₅)₃
S-3 H₂C═C(X)COOC₂H₄OCOC₅H₁₀OPO(OH)₂
S-4 (H₂C═C(X)COOC₂H₄OCOC₅H₁₀O)₂POOH
S-5 H₂C═C(X)COOC₂H₄OSO₃H
S-6 H₂C═C(X)COO(C₅H₁₀COO)₂H
S-7 H₂C═C(X)COOC₅H₁₀COOH
S-8 CH₂CH(O)CH₂OC₃H₆Si(OCH₃)₃
(X represents a hydrogen atom or CH₃)

The surfaces of the inorganic fine particles are preferably modified in solutions. In a case in which the inorganic fine particles are mechanically and finely dispersed, the surface modifier may be caused to coexist, the surface modifier may be added and stirred after the fine dispersion of the inorganic fine particles, or the surfaces may be modified (heating or a change in pH is carried out after an increase in temperature and drying as necessary) before the fine dispersion of the inorganic fine particles and then the inorganic fine particles may be finely dispersed. The solution that dissolves the surface modifier is preferably a highly polar organic solvent. Specific examples thereof include well-known solvents such as alcohols, ketones, and esters.

The average primary particle diameter of the inorganic fine particles (d) is preferably 10 nm to 100 nm and more preferably 10 to 60 nm. The average particle diameter of the fine particles can be obtained from electron micrographs. In a case in which the particle diameters of the inorganic fine particles (d) are too small, the hardness-improving effect cannot be obtained, and excessively large particle diameters cause an increase in haze.

The shape of the inorganic fine particles (d) may be a spherical shape or a non-spherical shape, but a non-spherical shape in which two to ten inorganic fine particles are coupled together is preferred from the viewpoint of imparting hardness. It is assumed that the use of several inorganic fine particles coupled together in a chain shape forms a strong particle network structure and thus improves hardness.

Specific examples of the inorganic fine particles (d) may include ELECOM V-8802 (spherical silica tine particles having an average particle diameter of 12 um manufactured by JGC Corporation), ELECOM V-8803 (irregular silica fine particles manufactured by JGC Corporation), MiBK-ST (spherical silica fine particles having an average particle diameter of 10 to 20 nm manufactured by Nissan Chemical Industries, Ltd.), MEK-AC-2140Z (spherical silica fine particles having an average particle diameter of 10 to 20 nm manufactured by Nissan Chemical Industries, Ltd.), MEK-AC-4130 (spherical silica fine particles having an average particle diameter of 40 to 50 nm manufactured by Nissan Chemical Industries, Ltd.), MiBK-SD-L (spherical silica fine particles having an average particle diameter of 40 to 50 nm manufactured by Nissan Chemical Industries, Ltd.), MEK-AC-5140Z (spherical silica fine particles having an average particle diameter of 70 to 100 nm manufactured by Nissan Chemical Industries, Ltd.), and the like. Among these, ELECOM V-8802 and MEK-AC-2140Z are preferred from the viewpoint of imparting hardness.

In a case in which the total solid contents of the composition for forming a hardcoat layer in the present invention are set to 100% by mass, the content of the inorganic fine particles (d) is 10% to 40% by mass, but preferably 15% to 30% by mass, and more preferably 15% to 25% by mass.

<<Ultraviolet Absorbent>>

The composition for forming a hardcoat layer of the present invention preferably includes an ultraviolet absorbent (also referred to as the ultraviolet absorbent (e)).

A hardcoat film of the present invention is used in polarizing plates, members for liquid crystal display devices, and the like, and, from the viewpoint of preventing the deterioration of polarizing plates, liquid crystals, and the like, an ultraviolet absorbent is preferably used. As the ultraviolet absorbent, an ultraviolet absorbent that does not significantly absorb visible light having a wavelength of 400 nm or longer is preferably used from the viewpoint of an excellent absorption capability of ultraviolet rays having a wavelength of 370 nm or shorter and favorable liquid crystal display properties. Only one kind of ultraviolet absorbent may be used or two or more kinds of ultraviolet absorbents may be jointly used. Examples thereof include the ultraviolet absorbents described in JP2001-72782A or JP2002-543265A. Specific examples of the ultraviolet absorbent include oxybenzophenone-based compounds, benzotriazole-based compounds, salicylic acid ester-based compounds, benzophenone-based compounds, cyanoacrylate-based compounds, nickel complex-based compounds, and the like.

<<Solvent>>

In the present invention, the composition for forming a hardcoat layer may contain a solvent. As the solvent, a variety of solvents can be used in consideration of the solubility of monomers, the dispersibility of light-transmissible particles, the drying properties during coating, and the like. Examples of relevant organic solvents include methyl alcohols such as dibutyl ether, dimethoxyethane, diethoxyethane, propylene oxide, 1,4-dioxane, 1,3-dioxolane, 1,3,5-trioxane, tetrahydrofuran, anisole, phenetol, dimethyl carbonate, methylethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, and ethyl acetoacetate, ethyl alcohol, isopropyl alcohol, n-butyl alcohol, cyclohexyl alcohol, isobutyl acetate, methyl isobutyl ketone (MIBK), 2-octanone, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethylcyclohexane, benzene, toluene, xylene, methanol, ethanol, tert-butyl alcohol, and the like, and one kind of solvent may be singly used or two or more kinds of solvents may be used in combination.

In the present invention, the solvent is used so that the concentration of the solid content of the composition for forming a hardcoat layer falls into a range of preferably 20% to 80% by mass, more preferably 30% to 75% by mass, and still more preferably 40% to 70% by mass.

The present inventors found that, even in a case in which a hardcoat layer produced using the composition for forming a hardcoat layer of the present invention is used as an underlayer, and furthermore, an upper layer is formed on the surface of the underlayer by means of coating, cissing does not easily occur during coating, and the upper layer having a uniform and even film surface can be produced. While not being confined to any theories, as described above, during coating, the surfaces of hardcoat layers made of the composition for forming a hardcoat layer including the fluorine-containing copolymer of the present invention which exhibits a surface-smoothening (leveling) function can be hydrophilized by carrying out a saponification treatment on the film, and, during the formation of the upper layer, it is possible to prevent the occurrence of cissing. Based on the above-described characteristics, in a case in which a layer formed of the composition for forming a hardcoat layer of the present invention is used as an underlayer, and an upper layer is formed on the surface of the underlayer by means of coating, as the solvent in coating solutions for forming the upper layer, a broad range of solvents can be used.

The composition for forming a hardcoat layer may also include additives such as a polymerization initiator in addition to (b) to (e).

(Radical Polymerization Initiator)

The composition for forming a hardcoat layer in the present invention may contain a radical polymerization initiator.

The compound having an ethylenic unsaturated bond can be polymerized by irradiation with ionizing radiation or heating in the presence of a photoradical polymerization initiator or a thermoradical polymerization initiator. As the photo- and thereto polymerization initiator, commercially available compounds can be used, and the commercially available compounds are described in “Advanced UV curing techniques” (p. 159, publisher: Kazuhiro Takasu, publishing company: Technical Information Institute Co., Ltd., published on 1991) or BASF's catalogues.

As the radical polymerization initiator, specifically, it is possible to use an alkylphenone-based photopolymerization initiator (IRGACURE 651, IRGACURE 184, DAROCURE 1173, IRGACURE 2959, IRGACURE 127, DAROCUREMBF, IRGACURE 907, IRGACURE 369, or IRGACURE 379 EG), an acylphosphine oxide-based photopolymerization initiator (IRGACURE 819 or LUCIRIN TPO), other radical polymerization initiator (IRGACURE 784, IRGACURE OXE01, IRGACURE OXE02, or IRGACURE 754), or the like.

In a case in which the total solid contents of the composition for forming a hardcoat layer in the present invention are set to 100% by mass, the amount of the radical polymerization initiator added is in a range of 0.1% to 10% by mass, preferably 1% to 5% by mass, and more preferably 2% to 4% by mass. In a case in which the amount added is less than 0.1% by mass, the polymerization does not sufficiently proceed, and the hardness of hardcoat layers is insufficient. On the other hand, in a case in which the amount added is more than 10% by mass, UV light does not reach the inside of films, and the hardness of hardcoat layers is insufficient. These radical initiators may be used singly or a plurality of kinds of radical initiators may be used in combination.

(Cationic Polymerization Initiator)

The composition for forming a hardcoat layer in the present invention may contain a cationic polymerization initiator.

Examples of the cationic polymerization initiator include well-known compounds such as well-known acid-generating agents that are used in photoinitiators of photocationic polymerization, photocolor-removing agents of pigments, photocolor-changing agents, microresists, and the like, mixtures thereof, and the like.

Examples thereof include onium compounds, organic halogen compounds, and disulfone compounds. Specific examples of the organic halogen compounds and the disulfone compounds include the same compounds as described in the section of compounds generating the above-described radicals.

Examples of the onium compounds include diazonium salts, ammonium salts, iminium salts, phosphonium salts, iodonium salts, sulfonium salts, arsonium salts, selenonium salts, and the like and include the compounds described in, for example, paragraphs [0058] and [0059] of JP2002-29162A and the like.

In the present invention, examples of cationic polymerization initiators that are particularly preferably used include onium salts, diazonium salts, iodonium salts, sulfonium salts, and iminium salts are preferred from the viewpoint of the photosensitivity of photopolymerization initiation, the material stability of compounds, and the like, and, among these, iodonium salts are most preferred from the viewpoint of light fastness.

In the present invention, specific examples of the onium salts that can be preferably used include amylated sulfonium salts described in paragraph [0035] of JP1997-268205A (JP-H09-268205A), diaryliodonium salts and triarylsulfonium salts described in paragraphs [0010] and [0011] of JP2000-71366A, sulfonium salts of thiobenzoate S-phenyl esters described in paragraph [0017] of JP2001-288205A, onium salts described in paragraphs [0030] to [0033] of JP2001-133696A, and the like.

Additional examples thereof include organic metal/organic halides, photoacid-generating agents having an o-nitrobenzyl-type protective group, and compounds such as compounds that are light-decomposed and thus generate sulfonic acid (iminosulfonate and the like) described in paragraphs [0059] to [0062] of JP2002-29162A.

As specific compounds of iodonium salt-based cationic polymerization initiators, it is possible to use B2380 (manufactured by Tokyo Chemical Industry Co., Ltd.), BBI-102 (manufactured by Midori Kagaku Co., Ltd.), WPI-113 (manufactured by Pure Wako Chemical Industries, Ltd.), WPI-124 (manufactured by Pure Wako Chemical Industries, Ltd.), WPI-169 (manufactured by Pure Wako Chemical Industries, Ltd.), WPI-170 (manufactured by Pure Wako Chemical Industries, Ltd.), and DTBPI-PFBS (manufactured by Toyo Gosei Co., Ltd.).

(Uneven Wind Inhibitor)

The composition for forming a hardcoat layer in the present invention may also contain an uneven wind inhibitor.

(Fluorine-Based Surfactant and Silicone-Based Surfactant)

The composition for forming a hardcoat layer may also contain a fluorine-based surfactant and a silicone-based surfactant; however, preferably, does not substantially include those surfactants since the surfactants enhance hydrophobicity and increase contact angles. In such a case, the surfaces of formed hardcoat layers do not easily become hydrophobic, and cissing does not easily occur during the formation of upper layers.

Specifically, the content of the fluorine-based surfactant and the silicone-based surfactant in the composition for forming a hardcoat layer is 0.05% by mass or less, preferably 0.01% by mass or less, and more preferably 0% by mass of the total mass of the composition for forming a hardcoat layer.

The fluorine-based surfactant is a compound which includes fluorine and is eccentrically located on the surface in the solvent that is used in the composition for forming a hardcoat layer. Examples of the fluorine-based surfactant having a hydrophobic part include compounds including fluorine among the compounds described as the orientation-controlling agent in paragraphs 0028 to 0034 of JP2011-191582A, the fluorine-based surfactant described in JP2841611B, the fluorine-based surfactant described in paragraphs 0017 to 0019 of JP2005-272560A, and the like.

Examples of the commercially available products of the fluorine-based surfactant include SURFLON manufactured by AGC Seimi Chemical Co., Ltd., MEGAFAC manufactured by DIC Corporation, and FTERGENT manufactured by NEOS Company Limited.

The silicone-based surfactant is a compound which includes silicone and is eccentrically located on the surface in the solvent that is used in compositions for producing optically functional layers.

Examples of the silicone-based surfactant include silicon atom-containing low-molecular-weight compounds such as polymethylphenylsiloxane, polyether-modified silicone oil, polyether-modified dimethylpolysiloxane, dimethylsilicone, diphenylsilicone, hydrogen-modified polysiloxane, vinyl-modified polysiloxane, hydroxy-modified polysiloxane, amino-modified polysiloxane, carboxyl-modified polysiloxane, chlorine-modified polysiloxane, epoxy-modified polysiloxane, methacryloxy-modified polysiloxane, mercapto-modified polysiloxane, fluorine-modified polysiloxane, long chain alkyl-modified polysiloxane, phenyl-modified polysiloxane, and silicone-modified copolymers.

Examples of the commercially available products of the silicone-based surfactant include KF-96 and X-22-945 manufactured by Shin-Etsu Chemical Co., Ltd., TORAY SILICONE DC3PA, TORAY SILICONE DC7PA, FORAY SILICONE SH11PA, TORAY SILICONE SH21PA, TORAY SILICONE SH28PA, TORAY SILICONE SH29PA, TORAY SILICONE SH30PA, and TORAY SILICONE FS-1265-300 (manufactured by Dow Corning Toray Co., Ltd.), TSF-4300, TSF-4440, TSF-4445, TSF-4446, TSF-4452, and TSF-4460 (manufactured by GE Toshiba Silicone Co., Ltd.), polysiloxane polymer KP341 (manufactured by Shin-Etsu Chemical Co., Ltd.), BYK-301, BYK-302, BYK-307, BYK-325, BYK-331, BYK-333, BYK-341, BYK-345, BYK-346, BYK-348, and BYK-375 (manufactured by BYK Japan KK), ARON GS-30 (manufactured by TOAGOSEI CO., LTD.), SILICONE L-75, SILICONE L-76, SILICONE L-77, SILICONE L-78, SILICONE L-79, SILICONE L-520, and SILICONE L-530 (manufactured by Nippon Unicar Co., Ltd.), and the like.

[Optical Film]

An optical film of the present invention has a layer that is formed of the composition containing the fluorine-containing copolymer of the present invention.

The optical film preferably has a layer that is formed of the composition containing the fluorine-containing copolymer of the present invention on a support.

<Support>

The support is preferably a transparent support having an average transmittance of visible light (400 to 800 nm) of 80% or more, and glass or polymer films can be used. Examples of the materials of the polymer film that is used as the support include cellulose acylate films (for example, cellulose triacetate films, cellulose diacetate films, cellulose acetate butyrate films, and cellulose acetate propionate films), polyolefins such as polyethylene and polypropylene, polyester-based resin films such as polyethylene terephthalate and polyethylene naphthalate, polyether sulfone films, polyacrylic resin films such as polymethyl methacrylate, polyurethane-based resin films, polyester films, polycarbonate films, polysulfone films, polyether films, polymethylpentene films, polyetherketone films, (meth)acrylnitrile films, polyolefins, polymers having an alicyclic structure (norbornene-based resins (ARTON: trade name, manufactured by JSR Corporation, amorphous polyolefins (ZEONEX: trade name, manufactured by Zeon Corporation)), and the like. Among these, cellulose acylate films are preferred.

The support may be a temporary support that is peeled off after the formation of hardcoat layers.

The film thickness of the support may be approximately 1 μm to 1,000 μm, but is preferably 1 μm to 100 μm and more preferably 1 μm to 25 μm since it is preferable to reduce the thickness for mobile uses.

[Hardcoat Film]

A hardcoat film of the present invention is one of the preferred forms of the optical film and has a layer that is formed of the composition containing the fluorine-containing copolymer of the present invention (preferably a hardcoat layer).

[Method For Manufacturing Hardcoat Film]

The hardcoat film of the present invention can be manufactured by applying the composition for forming a hardcoat layer onto the support, and drying and curing the composition so as to form a hardcoat layer. The support may be peeled off after the formation of the hardcoat layer.

<Coating Methods>

Individual layers in the hardcoat film of the present invention can be formed using the following coating methods, but the method is not limited thereto. Well-known methods such as a dip coating method, an air knife coating method, a curtain coating method, a roller coating method, a wire bar coating method, a gravure coating method, a slide coating method, an extrusion coating method (die coating method) (refer to the specification of JP2003-164788A), and a micro-gravure coating method can be used, and, among these, a micro-gravure coating method and a die coating method are preferred.

<Drying and Curing Conditions>

Regarding drying and curing methods in a case in which layers such as the hardcoat layer in the present invention are formed by means of coating, preferred examples will be described below.

In the present invention, it is effective to cure the composition by means of a combination of irradiation with ionizing radiation and a thermal treatment carried out before, at the same time, or after the irradiation.

Hereinafter, several patterns of manufacturing steps will be described, but the manufacturing steps are not limited thereto. (Reference sign “-” below indicates that no thermal treatment is carried out.)

Before irradiation→at the same time as irradiation→after irradiation
(1) Thermal treatment→ionizing radiation curing→-
(2) Thermal treatment→ionizing radiation curing→thermal treatment
(3) -→ionizing radiation curing→thermal treatment

Additionally, a step of carrying out a thermal treatment at the same time at the time of ionizing radiation curing is also preferred.

In the present invention, as described above, a thermal treatment is preferably carried out in combination with irradiation with ionizing radiation. The thermal treatment is not particularly limited as long as the thermal treatment does not impair constituent layers including the support in the hardcoat film and the hardcoat layer, but is preferably carried out at 40° C. to 150° C. and more preferably carried out at 40° C. to 80° C.

The time necessary for the thermal treatment varies depending on the molecular weights, interactions with other components, viscosities, and the like of components used, but is 15 seconds to 1 hour, preferably 20 seconds to 30 minutes, and most preferably 30 seconds to 5 minutes.

The kind of ionizing radiation is not particularly limited, examples thereof include X-rays, electron beams, ultraviolet rays, visible light, infrared rays, and the like, and ultraviolet rays are widely used. For example, in a case in which coated films are ultraviolet-curable, individual layers are preferably cured by being irradiated with ultraviolet rays at an irradiance level of 10 mJ/cm² to 1,000 mJ/cm² using an ultraviolet lamp. During irradiation, layers can be irradiated by striking the energy collectively or separately. Particularly, from the viewpoint of decreasing performance variation in the planes of coated films or improving curling, layers are preferably irradiated separately twice or more and preferably irradiated at a low irradiance level of 150 mJ/cm² or less in the initial phase, then, irradiated with ultraviolet rays at a high irradiance level of 50 mJ/cm² or more, and irradiated at a higher irradiance level in the later phase than in the initial phase. From the viewpoint of hardness, the total irradiance level is preferably 100 mJ/cm² to 1,000 mJ/cm², more preferably 300 mJ/cm² to 1,000 mJ/cm², and most preferably 500 mJ/cm² to 1,000 mJ/cm².

The hardcoat film of the present invention is preferably manufactured using the method for manufacturing a hardcoat film of the present invention.

The hardcoat film of the present invention is generally a constitution in which a hardcoat layer is provided on a transparent support by means of coating in the simplest constitution.

Preferred examples of the layer constitution of the hardcoat film of the present invention will be described below, but the layer constitution is not particularly limited to these layer constitutions.
Support/hardcoat layer
Support/hardcoat layer/low-refractive index layer
Support/hardcoat layer/anti-glare layer (antistatic layer)/low-refractive index layer
Support/hardcoat layer/anti-glare layer/antistatic layer/low-refractive index layer
Support/hardcoat layer/antistatic layer/anti-glare layer/low-refractive index layer
Support/hardcoat layer/antistatic layer (anti-glare layer)/low-refractive index layer
Support/hardcoat layer/high-refractive index layer/antistatic layer/low-refractive index layer
Support/hardcoat layer/high-refractive index layer/(antistatic layer)/low-refractive index layer
Support/hardcoat layer/antistatic layer/high-refractive index layer/low-refractive index layer
Support/hardcoat layer/middle-refractive index layer/high-refractive index layer (antistatic layer)/low-refractive index layer
Support/hardcoat layer/middle-refractive index layer (antistatic layer)/high-refractive index layer/low-refractive index layer
Support/hardcoat layer (antistatic layer)/middle-refractive index layer/high-refractive index layer/low-refractive index layer
Support/antistatic layer/hardcoat layer/middle-refractive index layer/high-refractive index layer/low-refractive index layer
Antistatic layer/support/hardcoat layer/middle-refractive index layer/high-refractive index layer)/low-refractive index layer

Here, the antistatic layer and the anti-glare layer may be hardcoatable.

The film thickness of the hardcoat layer of the present invention can be selected depending on the target hardness, but is preferably 1 to 50 μm. This is because the hardcoat film of the present invention curls only to an extremely small extent, and thus, even in a case in which hardcoat layers are formed to be thick, there is no problem with handling. Meanwhile, in the case of being used as a polarizer protective film, the thickness of the hardcoat layer is preferably designed to be 3 to 10 μm.

The hardcoat film of the present invention does not easily cause the cissing of coating compositions for upper layers and is capable of forming uniform upper layers in the case of being used to produce laminate films in which upper layers are laminated as described above.

<Polarizing Plate>

A polarizing plate of the present invention has a layer that is formed of the composition containing the fluorine-containing copolymer of the present invention.

The polarizing plate of the present invention preferably has at least one hardcoat film of the present invention and preferably includes a polarizer and the hardcoat film of the present invention which is attached to the polarizer after a saponification treatment.

The hardcoat film of the present invention can be used as a polarizing plate protective film. In the case of being used as a polarizing plate protective film, the method for producing the polarizing plate is not particularly limited, and the polarizing plate can be produced using an ordinary method. Examples of the ordinary method include a method in which the obtained hardcoat film is alkali-treated and attached to both surfaces of a polarizer produced by immersing and stretching a polyvinyl alcohol film in an iodine solution using an aqueous solution of a fully-saponified polyvinyl alcohol. Instead of the alkali treatment, easy-adhesion processing as described in JP1994-94915A (JP-H06-94915A) or JP1994-118232A (JP-H06-118232A) may be carried out. In addition, the surface treatment as described above may also be carried out. The attachment surface of the optical film to the polarizer may be a surface on which a film is laminated as a layer of low moisture permeability or a surface on which no film is laminated.

Examples of an adhesive that is used to attach a protective film-treated surface and the polarizer include polyvinyl alcohol-based adhesives such as polyvinyl alcohol and polyvinyl butyral, vinyl-based latexes such as butyl acrylate, and the like.

The polarizing plate is constituted of the polarizer and protective films that protect both surfaces of the polarizer and constituted by further attaching a protect film on one surface of the polarizing plate and a separate film on the opposite surface. The protect film and the separate film are used to protect the polarizing plate at the time of the shipping of the polarizing plate, product inspection, and the like. In this case, the protect film is attached to protect the surface of the polarizing plate and is used on a surface opposite to a surface on which the polarizing plate is attached to a liquid crystal plate. In addition, the separate film is used to cover an adhesive layer that is attached to the liquid crystal plate and is used on the surface on which the polarizing plate is attached to a liquid crystal plate.

<Touch Panel Display>

A touch panel display of the present invention includes a liquid crystal cell and the polarizing plate of the present invention on a viewer side of the liquid crystal cell and includes an optically clear adhesive (OCA) or an optically clear resin (OCR) on a surface of the polarizing plate opposite to the liquid crystal cell.

Examples of OCR include HRJ series manufactured by Kyoritsu Chemical & Co., Ltd., SA series manufactured by Dexerials Corporation, and the like.

### EXAMPLES

Hereinafter, the present invention will be more specifically described using examples. Materials, reagents, amounts and fractions of substances, operations, and the like described in the following examples can be appropriately changed within the scope of the gist of the present invention. Therefore, the scope of the present invention is not limited to the following examples.

### Synthesis Example 1

### Synthesis Example of Fluorine-Containing Copolymer B-1

Methyl ethyl ketone (15.0 g) was prepared in a 200-milliliter three-neck flask equipped with a stirrer, a thermometer, a reflux cooling pipe, and a nitrogen gas introduction pipe and heated up to 75° C. Next, a mixed solution made up of 2-(perfluorohexyl)ethyl acrylate (4.00 g, 9.6 millimoles), vinyl acetate (14.00 g, 162.6 millimoles), BLEMMER AME-400 (manufactured by NOF Corporation) (2.00 g, 4.1 millimoles), methyl ethyl ketone (15.0 g), and “V-601” (manufactured by Pure Wako Chemical Industries, Ltd.) (1.556 g) was added dropwise at a constant rate so that the dropwise addition was completed in 180 minutes. After the completion of the dropwise addition, the mixed solution was further continuously stirred for two hours, heated up to 87° C., and further continuously stirred for five hours, thereby obtaining a methyl ethyl ketone solution of a fluorine-containing copolymer B-1 of the present invention (43.6 g). The weight-average molecular weight (Mw) of this polymer was 3,600 (computed in terms of polystyrene under measurement conditions of an eluent of THF, a flow rate of 0.35 ml/min, and a temperature of 40° C. by means of gel permeation chromatography (EcoSEC HLC-8320GPC (manufactured by Tosoh Corporation)), the columns used were TSKgel Super HZM-H, TSKgel Super HZ4000, and TSKgel Super HZ200 (manufactured by Tosoh Corporation)). In addition, the structure was identified using the ¹H-nuclear magnetic resonance (NMR) spectrum of the obtained polymer, and the compositional ratio was determined.

¹H-NMR (CDCl₃) 67 : 3.3 to 3.4 (3H, polyethyleneoxy group terminal derived from AME-400 CH3), 4.0 to 4.2 and 4.3 to 4.5 (2H, derived from a methylene group of 2-(perfluorohexyl)ethylacrylate), 4.8 to 5.2 (1H, derived from a methyl group of vinyl acetate).

### Synthesis Examples 2 to 13

Fluorine-containing copolymers B-2 to B-12 of the present invention were synthesized in the same manner except for the fact that the monomer and the compositional ratio used in Synthesis Example 1 were changed as shown in Table 1 respectively. Meanwhile, in both Synthesis Example 5 and Synthesis Example 10, fluorine-containing copolymers of the structure of B-5 were synthesized, but the contents of the repeating unit were different from each other.

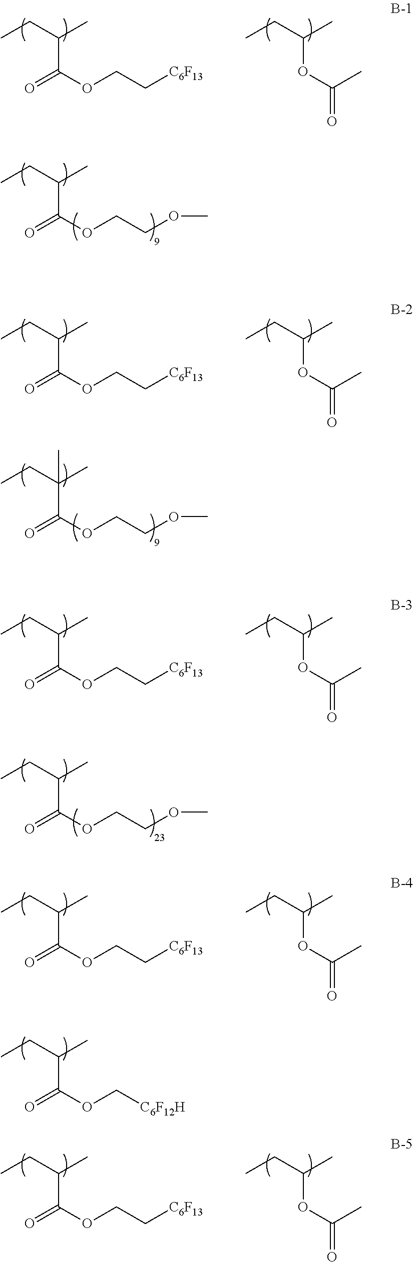

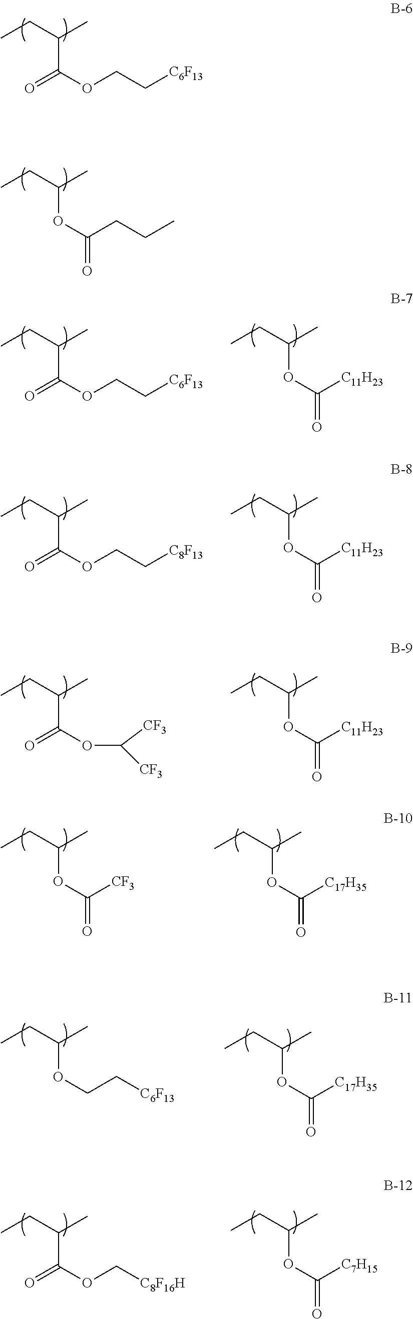

TABLE 1

| | | Repeating unit | | Repeating unit | | Repeating unit | | | | Molecular | | |
|---|---|---|---|---|---|---|---|---|---|---|---|---|
| | | represented by | | represented by | | represented by | | | | weight | | |
| | | General Formula | | General Formula | | General Formula | | Polymerization | | (GPC) | | |
| | | (I) | | (II) | | (IV) | | initiator | | Mw | Mn | |
| | | Kind | % by mass | Kind | % by mass | Kind | % by mass | Kind | % by mass | (k) | (k) | Mw/Mn |
| B-1 | Synthesis | C6FA | 20 | VAc | 70 | AME-400 | 10 | V-601 | 3.8 | 3.6 | 1.4 | 2.56 |
| | Example 1 | | | | | | | | | | | |
| B-2 | Synthesis | C6FA | 20 | VAc | 70 | PME-400 | 10 | V-601 | 3.8 | 3.8 | 1.4 | 2.64 |
| | Example 2 | | | | | | | | | | | |
| B-3 | Synthesis | C6FA | 20 | VAc | 70 | AM-230G | 10 | V-601 | 2.5 | 4.2 | 1.6 | 2.63 |
| | Example 3 | | | | | | | | | | | |
| B-4 | Synthesis | C6FA/C6FHA | 20/10 | VAc | 70 | None | — | V-601 | 3.8 | 2.8 | 1.2 | 2.38 |
| | Example 4 | | | | | | | | | | | |
| B-5 | Synthesis | C6FA | 20 | VAc | 80 | None | — | V-601 | 0.9 | 4.6 | 2.2 | 2.07 |
| | Example 5 | | | | | | | | | | | |
| B-6 | Synthesis | C6FA | 30 | VB | 70 | None | — | V-601 | 0.9 | 5.2 | 2.3 | 2.26 |
| | Example 6 | | | | | | | | | | | |
| B-7 | Synthesis | C6FA | 25 | VL | 75 | None | — | V-601 | 1.2 | 4.4 | 1.9 | 2.32 |
| | Example 7 | | | | | | | | | | | |
| B-8 | Synthesis | C8FA | 30 | VL | 70 | None | — | V-601 | 2.4 | 4.8 | 2.1 | 2.29 |
| | Example 8 | | | | | | | | | | | |
| B-9 | Synthesis | HFMA | 20 | VL | 80 | None | — | V-601 | 2.1 | 4.2 | 1.9 | 2.21 |
| | Example 9 | | | | | | | | | | | |
| B-5 | Synthesis | C6FA | 70 | VAc | 30 | None | — | V-601 | 2.2 | 5.9 | 2.2 | 2.68 |
| | Example 10 | | | | | | | | | | | |
| B-10 | Synthesis | CF3VAc | 40 | VS | 60 | None | — | V-601 | 2.3 | 5.5 | 2.1 | 2.62 |
| | Example 11 | | | | | | | | | | | |
| B-11 | Synthesis | C6FVE | 50 | VS | 50 | None | — | V-601 | 1.8 | 6.5 | 2.8 | 2.32 |
| | Example 12 | | | | | | | | | | | |
| B-12 | Synthesis | C8FHA | 45 | VN-O | 55 | None | — | V-601 | 3.1 | 4.7 | 1.9 | 2.47 |
| | Example 13 | | | | | | | | | | | |

Meanwhile, abbreviations in Table 1 indicate the following substances.
C6FHA: 1H, 1H, 7H-dodecafluoroheptyl acrylate
C8FHA: 1H, 1H, 9H-dodecafluorononyl acrylate
C6FA: 2-(perfluorohexyl)ethyl acrylate
C8FA: 2-(perfluorooctyl)ethyl acrylate
HFMA; 1,1,1,3,3,3-hexafluoroisopropyl methacrylate
C6FVE: (3,3,4,4,5,5,6,6,7,7,8,8,8-tridecafluorooctyl)vinyl ether
CF3VAc: vinyl trifluoroacetate
VAc: vinyl acetate
VB: vinyl butyrate
VN-O: vinyl n-octanoate
VL: vinyl laurate
VS: vinyl stearate
AME-400: BLEMMER AME-400 (manufactured by NOF Corporation)
PME-400: BLEMMER PME-400 (manufactured by NOF Corporation)
AM-230G: NK Ester AM-230G (manufactured by Shin-Nakamura Chemical Co., Ltd.)

In addition, the molecular weights in Table 1 have a metric prefix of kilo (k), and, for example, 3.6k indicates 3.600.

### Preparation of Hardcoat Layer Coating Solution A-1

Individual components were mixed together so as to obtain the following composition, thereby preparing a hardcoat layer coating solution A-1 in which the solid content concentration reached approximately 55% by mass.

Composition of hardcoat layer coating solution A-1

| | |
|---|---|
| Dipenthaerythiritol hexaacrylate (DPHA): | 29.6 parts by mass |
| KAYARD DPHA (manufactured by | |
| Nippon Kayaku Co., Ltd.) (hexafunctional) | |
| IRGACURE 184: Alkylphenone-based | 2.20 parts by mass |
| photopolymerization initiator | |
| (manufactured by BASF) | |
| 3,4-Epoxycyclohexylmethyl methacrylate: | 13.8 parts by mass |
| CYCLOMER M100 (Daicel Corporation, | |
| molecular weight: 196) | |
| Compound 1 | 0.55 parts by mass |
| Fluorine-containing copolymer B-1 | 0.06 parts by mass |
| (Synthesis Example 1) | |
| MEK-AC-2140Z (average particle diameter: | 8.25 parts by mass |
| 10 to 20 nm, spherical silica fine particles | |
| (manufactured by Nissan | |
| Chemical Industries, Ltd.)) | |
| Tinuvin928: Benzotriazole-based ultraviolet | 0.55 parts by mass |
| absorbent (manufactured by BASF) | |
| MEK: Methyl ethyl ketone | 16.7 parts by mass |
| MiBK: MEthyl isobutyl ketone | 19.8 parts by mass |
| Methyl acetate: | 8.5 parts by mass |
| Compound 1: | |
| Compound 1 was stnyhesized using the | |
| method described in Example 1 of JP4841935B. | |
| 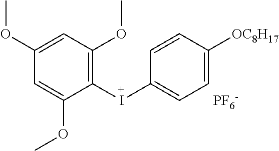 | |

### Preparation of Hardcoat Layer Coating Solutions A-2 to A-17

Hardcoat layer coating solutions A-2 to A-17 were produced in the same manner as described above except for the fact that the fluorine-containing copolymer B-1 was changed to the fluorine-containing copolymers B-2 to B-12 and H-1 to 3 or the fluorine-containing copolymer B-1 was not added thereto.

### Production of 40 μm Acrylic Base Material Film

Methyl methacrylate (MMA) (8,000 g), methyl 2-(hydroxymethyl)acrylate (MHMA) (2,000 g)and toluene (10,000 g) as a polymerization solvent were prepared in a reaction vessel which included a stirring device, a temperature sensor, a cooling pipe, and a nitrogen introduction pipe and had an inner capacity of 30 L and heated up to 105° C. under the flow of nitrogen. At the time of reflux initiated by the increase in temperature, t-amyl peroxyisonoate (10.0 g) was added thereto as a polymerization initiator, solution polymerization was caused under reflux at approximately 105° C. to 110° C. while a solution made up of t-amyl peroxyisonoate (20.0 g) and toluene (100 g) was added dropwise thereto for two hours, and furthermore, the components were aged for four hours. The polymerization reaction percentage was 96.6%, and the content ratio (mass ratio) of MHMA in the obtained polymer was 20.0%.

Next, a stearyl phosphate/distearyl phosphate mixture (manufactured by Sakai Chemical industry Co., Ltd., Phoslex A-18) (10 g) was added to the obtained polymerization solution, and a cyclocondensation reaction was caused for five hours under reflux at approximately 80° C. to 100° C.

Next, the obtained polymerization solution was introduced into a vent-type twin screw extruder (φ=29.75 mm, L/D=30) having a barrel temperature of 260° C., a rotation rate of 100 rpm, a depressurization degree of 13.3 to 400 hPa (10 to 300 mmHg), one rear vent, and four front vents at a treatment rate of 2.0 kg/hour in terms of the resin amount, and a cyclocondensation reaction and devolatilization were carried out in the extruder. Next, after the completion of the devolatilization, a thermally-molten resin left in the extruder was discharged through the tip of the extruder and pelletized using a pelletizer, thereby obtaining transparent pellets made of an acrylic resin having a lactone ring structure in the main chain. The weight-average molecular weight of this resin was 148,000, the melt flow rate (obtained according to JIS K7120 at a testing temperature of 240° C. and a load of 10 kg which will be applied to the following manufacturing examples) was 11.0 g/10 minutes, and the glass transition temperature was 130° C.

Next, the obtained pellets and an AS resin (manufactured by Toyo Styrene Co., Ltd., trade name: TOYO AS AS20) were kneaded in a weight ratio of 90/10 (pellets/AS resin) using a monoaxial extruder (φ=30 mm), thereby obtaining transparent pellets having a glass transition temperature of 127° C.

The pellets of the resin composition produced above were melt-extruded from a coat hanger-type T die using a biaxial extruder, thereby producing a resin film having a thickness of approximately 160 μm.

Next, the obtained non-stretched resin film was biaxially stretched 2.0 times in the vertical direction (longitudinal direction) and 2.0 times in the horizontal direction (width direction) at the same time, thereby producing a polarizer protective film. The acrylic base material film obtained as described above has a thickness of 40 μm, a total light transmittance of 92%, a haze of 0.3%, and a glass transition temperature of 127° C.

### Provision of Hardcoat Layer by Means of Coating

A support selected from a 80 μm-thick commercially available triacetyl cellulose film (manufactured by Fujifilm Corporation) (abbreviated as “TAC80” in Table 2), TJ25 (manufactured by Fujifilm Corporation), and the 40 μm acrylic base material film (abbreviated as “acryl” in Table 2), all of which were unwound in a roll form, and the hardcoat layer coating solutions A-1 to A-17 were used, thereby producing hardcoat films S-01 to S-21.

Specifically, each of the coating solutions was applied onto the support under a condition of a transportation rate of 30 m/minute using a die coating method in which the slot die described in Example 1 of JP2006-122889A was used, dried at 60° C. for 150 seconds, then, furthermore, irradiated with ultraviolet rays at an illuminance of 400 mW/cm² and an irradiance level of 500 mJ/cm² using a 160 W/cm air-cooling metal halide lamp (manufactured by Eye Graphics Co., Ltd.) under nitrogen purging at an oxygen concentration of approximately 0.1% by volume so as to cure the coated layer, whereby a hardcoat layer was formed and then wound.

The produced hardcoat films S-01 to S-21 were evaluated using the following evaluation method.

### Film Thickness of Hardcoat Layer

The film thickness of the hardcoat layer was computed by measuring the film thickness of the produced hardcoat film using a contact-type film thickness meter and subtracting the thickness of the supporter measured in the same manner from the film thickness. The film thickness of the hardcoat layer was 6.0 μm in all of the hardcoat films S-01 to S-21.

### Interference Unevenness of Hardcoat Layer

In order to prevent reflection on a surface (rear surface) of the hardcoat film opposite to the hardcoat layer, the rear surface was fully covered with a black marker, and then the front surface (the hardcoat layer-coated surface) of the hardcoat film was observed under a three-wavelength fluorescent lamp having a diffusion plate attached to the front surface. The hardcoat film was visually observed from the front surface and evaluated using the following evaluation standards.

A: There were no interference fringes

B: An extremely small number of interference fringes were observed, but the interference fringes were not on a concerning level.

C: Interference fringes were observed here and there, but remained in a permissible range as products.

D: Interference fringes were excessively generated and on a concerning level.

### Seed-Like Defects in Hardcoat Layer

The rear surface was irradiated with a fluorescent lamp, three square meters of the rear surface was inspected by means of the transmission visual surface inspection from the hardcoat layer-coated surface (front surface) side and the reflection visual surface inspection irradiated with the fluorescent lamp from the hardcoat layer-coated surface side, and bright spot-like defects were collected. Furthermore, the collected defects were analyzed using a microscope, IR, and a microscopic Raman spectral instrument, the number of defect portions having the same composition as that of the normal portion was counted, and the value was divided by three, thereby computing the number of seed-like defects per square meter.

A: The number of seed-like defects per square meter was zero, and no seed-like defects were generated.

B: The number of seed-like defects per square meter was one to five, but the frequency was low, and the seed-like defects were not on a concerning level.

C: The number of seed-like defects per square meter was six or more, and the seed-like defects were on a concerning level.

### Saponification of Hardcoat Film

After the produced hardcoat film was immersed in an aqueous solution of I.5 mol/L of NaOH (saponification solution) held at 45° C. for two minutes, the film was washed with water, then, immersed in an aqueous solution of 0.1 mol/L of sulfuric acid (30° C.) for 15 seconds, and then caused to pass through a water-washing bath for 100 seconds under flowing water, thereby putting the film into a neutral state. In addition, water was repeatedly removed three times using an air knife, and the film was dried by being held in a drying zone at 90° C. for 60 seconds after the dropping of water, thereby producing a saponified film.

### Contact Angle of Water

A 3 μL liquid droplet was produced in a dried state (20° C./65% RH) at a needle tip using a contact angle meter [“CA-X”-type contact angle meter, manufactured by Kyowa Interface Science Co., Ltd.] and pure water as liquid and brought into contact with the surface of the hardcoat layer in the saponified hardcoat film, thereby producing a liquid droplet on the film. The angle on a side including the liquid was measured from the angle formed by a normal line to the liquid surface and the film surface at a point at which the film and the liquid came into contact with each other in ten seconds after the dropwise addition and considered as the contact angle. The contact angle was evaluated on the basis of the results using the following standards.

A: The contact angle was 50° or less.

B: The contact angle was more than 50° and 60° or less.

C: The contact angle was more than 60° and 75° or less.

D: The contact angle was more than 75°.

### Cissing at Time of Being Laminated on Hardcoat Layer

### Preparation of Lamination Coating Solution Ln-1

Individual components were mixed together as described below and dissolved in a MEK/MMPG-Ac mixture (mass ratio of 90/10), thereby preparing a low-refractive index layer coating solution having a solid content of 1% by mass.

<<Composition of Ln-1>>

| | |
|---|---|
| Perfluoroolefin copolymer (P-1) described below | 15.0 g |
| DPHA | 7.0 g |
| RMS-033 | 5.0 g |
| Fluorine-containing monomer (M-1) described below | 20.0 g |
| Hollow silica particles (in terms of solid content) 50.0 g | |
| IRGACURE 127 | 3.0 g |
| Compounds used will be illustrated below. | |
| Perfluoroolefin copolymer (P-1) | |
| 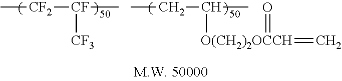 | |
| In the structural formula, 50:50 indicates the molar ratio | |
| Fluorine-containing monomer (M-1) | |
| 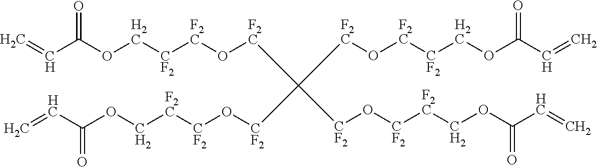 [SMILES: C=CC(=O)OCC(F)(F)C(F)(F)OC(F)(F)C(C(F)(F)OC(F)(F)C(F)(F)COC(=O)C=C)(C(F)(F)OC(F)(F)C(F)(F)COC(=O)C=C)C(F)(F)OC(F)(F)C(F)(F)COC(=O)C=C] | |

DPHA: KAYARD DPHA (manufactured by Nippon Kayaku Co., Ltd.)
RMS-033: Silicone-based polyfunctional acrylate (manufactured by Gelest, Inc., Mw=28,000)
IRGACURE 127: Acylphosphine oxide-based photopolymerization initiator (manufactured by BASF)
Hollow silica particles: Hollow silica particle dispersion liquid (average particle size: 45 nm, refractive index: 1.25, the surface was treated with a silane coupling agent having an acryloyl group, MEK dispersion liquid concentration: 20%)
MEK: Methyl ethyl ketone
MMPG-Ac: Propylene glycol monomethyl ether acetate

The low-refractive index layer coating solution was filtered using a polypropylene filter having a pore diameter of 1 μm, thereby preparing a coating solution.

Next, the low-refractive index layer coating solution Ln-1 was applied on the side provided with the hardcoat layer in the hardcoat film saponified as described above. The drying conditions of the low-refractive index layer were 90° C. and 60 seconds, and, regarding the ultraviolet curing conditions, the illuminance was set to 600 mW/cm² and the irradiance level was set to 300 mJ/cm² under nitrogen purging using a 240 W/cm air-cooling metal halide lamp (manufactured by Eye Graphics Co., Ltd.) so as to form an atmosphere in which the oxygen concentration reached 0.1% by volume or less. The low-refractive index layer has a refractive index of 1.36 and a film thickness of 95 nm. Five square meters of the obtained film was inspected, and the number of cissing portions was counted. Here, regions in which no upper layer was formed on the surface of the underlayer were considered as cissing portions. The cissing was evaluated on the basis of the results using the following standards.

A: The number of cissing portions was zero, and no cissing was caused.

B: The number of cissing portions was one to five, cissing was rarely caused, and there was no problem.

C: The number of cissing portions was six to twenty and remained in a permissible range.

D: The number of cissing portions was 21 or more, and there were problems.

The above-described results are shown in Table 2.

TABLE 2

| | | Constitution | | | | Evaluation results | | | |
|---|---|---|---|---|---|---|---|---|---|
| | | Hardcoat | Fluorine- | | Film thickness of | Interference | | | |
| | Hardcoat | layer coating | containing | | hardcoat layer | unevenness in | Seed-like defects | Contact angle | Cissing in |
| | film | solution | copolymer | Support | (μm) | hardcoat layer | in hardcoat layer | of water | lamination |
| Example | S-01 | A-1 | Synthesis | TJ25 | 6.0 | A | A | A | A |
| | | | Example 1 | | | | | | |
| Example | S-02 | A-2 | Synthesis | TJ25 | 6.0 | A | A | A | A |
| | | | Example 2 | | | | | | |
| Example | S-03 | A-3 | Synthesis | TJ25 | 6.0 | A | A | A | A |
| | | | Example 3 | | | | | | |
| Example | S-04 | A-4 | Synthesis | TJ25 | 6.0 | A | A | B | B |
| | | | Example 4 | | | | | | |
| Example | S-05 | A-5 | Synthesis | TJ25 | 6.0 | A | B | A | A |
| | | | Example 5 | | | | | | |
| Example | S-06 | A-5 | Synthesis | TAC80 | 6.0 | A | B | A | A |
| | | | Example 5 | | | | | | |
| Example | S-07 | A-5 | Synthesis | Acryl | 6.0 | A | B | A | A |
| | | | Example 5 | | | | | | |
| Example | S-08 | A-6 | Synthesis | TJ25 | 6.0 | A | B | B | A |
| | | | Example 6 | | | | | | |
| Example | S-09 | A-7 | Synthesis | TJ25 | 6.0 | A | B | B | B |
| | | | Example 7 | | | | | | |
| Example | S-10 | A-8 | Synthesis | TJ25 | 6.0 | A | B | C | B |
| | | | Example 8 | | | | | | |
| Example | S-11 | A-9 | Synthesis | TJ25 | 6.0 | C | B | C | B |
| | | | Example 9 | | | | | | |
| Example | S-12 | A-10 | Synthesis | TJ25 | 6.0 | A | B | C | B |
| | | | Example 10 | | | | | | |
| Example | S-13 | A-11 | Synthesis | TJ25 | 6.0 | C | A | C | C |
| | | | Example 11 | | | | | | |
| Example | S-14 | A-12 | Synthesis | TJ25 | 6.0 | B | A | C | C |
| | | | Example 12 | | | | | | |
| Example | S-15 | A-13 | Synthesis | TJ25 | 6.0 | A | B | C | B |
| | | | Example 13 | | | | | | |
| Comparative | S-16 | A-14 | — | TJ25 | 6.0 | D | A | B | B |
| Example | | | | | | | | | |
| Comparative | S-17 | A-15 | H-1 | TJ25 | 6.0 | B | B | D | D |
| Example | | | | | | | | | |
| Comparative | S-18 | A-15 | H-1 | TAC80 | 6.0 | B | B | D | D |
| Example | | | | | | | | | |
| Comparative | S-19 | A-15 | H-1 | Acryl | 6.0 | B | B | D | D |
| Example | | | | | | | | | |
| Comparative | S-20 | A-16 | H-2 | TJ25 | 6.0 | B | C | D | D |
| Example | | | | | | | | | |
| Comparative | S-21 | A-17 | H-3 | TJ25 | 6.0 | B | B | D | D |
| Example | | | | | | | | | |

(H-1) (Compound of Example 1 of JP2005-248116A)

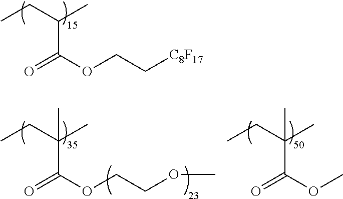

(H-2) (Compound of Example 1 of JP2000-102727A)

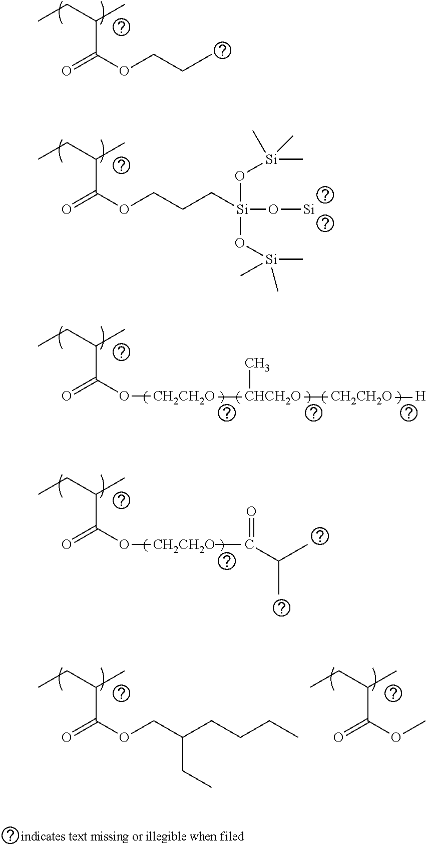

(H-3)

F-552: Commercially available fluorine-based surface modifier (manufactured by DIC Corporation, trade name: MEGAFAC F-552)

Next, examples in which the fluorine-containing copolymer is a branched polymer or a block copolymer will be described.

### <Synthesis of Branched Polymer

### Synthesis of Trunk Polymer

Methyl ethyl ketone (10.0 g) was prepared in a 200-milliliter three-neck flask equipped with a stirrer, a thermometer, a reflux cooling pipe, an oil bath, and a nitrogen gas introduction pipe and heated up to 78° C. Next, a mixed solution made up of vinyl acetate (1.5.0 g, 174.2 millimoles), glycidyl methacrylate (GLM) (2 g, 14.1 millimoles), BLEMMER AME-400 (manufactured by NOF Corporation) (3 g, 6.2 millimoles), methyl ethyl ketone (10.0 g), and “V-601” (manufactured by Pure Wako Chemical Industries, Ltd.) (1.34 g) was added dropwise at a constant rate so that the dropwise addition was completed in 180 minutes. After the completion of the dropwise addition, the mixed solution was further continuously stirred for five hours, thereby obtaining a methyl ethyl ketone solution (41.0 g) of a trunk polymer AA-1. The weight-average molecular weight (Mw) of this polymer was 6,800 (computed in terms of polystyrene under measurement conditions of an eluent of THF, a flow rate of 0.35 ml/min, and a temperature of 40° C. by means of gel permeation chromatography (EcoSEC HLC-8320GPC (manufactured by Tosoh Corporation)), the columns used were TSKgel Super HZM-H, TSKgel Super HZ4000, and TSKgel SuperHZ200 (manufactured by Tosoh Corporation)). In addition, the structure was identified using the ¹H-nuclear magnetic resonance (NMR) spectrum of the obtained polymer, and the compositional ratio was determined.

### Synthesis of Branch Polymer

Methyl ethyl ketone (10.0 g) was prepared in a 200-milliliter three-neck flask equipped with a stirrer, a thermometer, a reflux cooling pipe, an oil bath, and a nitrogen gas introduction pipe and heated up to 78° C. Next, a mixed solution made up of 2-(perfluorohexyl)ethyl acrylate (20 g, 47.8 millimoles), 3-mercaptopropionic acid (0.51 g, 4.8 millimoles), methyl ethyl ketone (10.0 g), and “V-501” (manufactured by Pure Wako Chemical Industries, Ltd.) (0.13 g) was added dropwise at a constant rate so that the dropwise addition was completed in 180 minutes. After the completion of the dropwise addition, the mixed solution was further continuously stirred for five hours, thereby obtaining a methyl ethyl ketone solution (40.0 g) of a branch polymer BB-1. The weight-average molecular weight (Mw) of this polymer was 2,100.

### Syntheses of Branched Polymers

A methyl ethyl ketone solution (10.0 g) of the trunk polymer AA-1 was prepared in a 200-milliliter three-neck flask equipped with a stirrer, a thermometer, and a reflux cooling pipe and heated up to 78° C. Next, a methyl ethyl ketone solution (14.3 g) of the branch polymer BB-1 and tetrabutylammonium bromide (0.1 g) were added thereto and stirred for 12 hours. After the end of a reaction, the components were purified by being reprecipitated in methanol, thereby obtaining a branched polymer C-1 which is the fluorine-containing copolymer of the present invention. The weight-average molecular weight (Mw) of the polymer of the branched polymer C-1 was 8,300,

Trunk polymers AA-2 to AA-10, branch polymers BB-2 to BB-7, and BB-9 were synthesized in the same manner except for the fact that the kind and weight-average molecular weight of the monomer were changed to the contents shown in Table 3. In addition, branched polymers C-2 to C-12, Z-1, and Z-2 were synthesized in the same manner except for the fact that the ratio between the branch polymer and GLM was changed to the contents shown in Table 3. Numerical values in the column “monomer compositional ratio” in Table 3 respectively correspond to monomers sequentially described in the column “monomer composition” from the left.

### Synthesis of Branch Polymer BB-8

Methyl ethyl ketone (10.0 g) was prepared in a 200-milliliter three-neck flask equipped with a stirrer, a thermometer, a reflux cooling pipe, an oil bath, and a nitrogen gas introduction pipe and heated up to 78° C. Next, a mixed solution made up of 2-(perfluorohexyl)ethyl acrylate (20 g, 47.8 millimoles), 2-mercaptoethanol (0.38 g, 4.8 millimoles), methyl ethyl ketone (10.0 g), and “V-501” (manufactured by Pure Wako Chemical Industries, Ltd.) (0.13 g) was added dropwise at a constant rate so that the dropwise addition was completed in 180 minutes. After the completion of the dropwise addition, the mixed solution was further continuously stirred for five hours, thereby obtaining a methyl ethyl ketone solution (40.0 g) of a branch polymer BB-8. The weight-average molecular weight (Mw) of this polymer was 7,200.

### Synthesis of Branched Polymer C-13

A methyl ethyl ketone solution (10.0 g) of the trunk polymer AA-9 was prepared in a 200-milliliter three-neck flask equipped with a stirrer, a thermometer, and a reflux cooling pipe and heated up to 78° C. Next, a methyl ethyl ketone solution (12.7 g) of the branch polymer BB-8 and NEOSTANN U-830 (manufactured by Nitto Kasei Co., Ltd.) (0.1 g) were added thereto and stirred for 12 hours. After the end of a reaction, the components were purified by being reprecipitated in methanol, thereby obtaining a branched polymer C-13 which is the fluorine-containing copolymer of the present invention. The weight-average molecular weight (Mw) of the polymer of the branched polymer C-13 was 14,400.

TABLE 3

| | | | Truck polymer | | | | | | | |
|---|---|---|---|---|---|---|---|---|---|---|
| | | | | | | | Monomer | | | |
| | | | | | | | compositional | | | |
| | Shape of | | | | | | ratio | | | |
| | polymer | No. | No. | Monomer composition | | | (% by mass) | | | Mw |
| Example | Branched | C-1 | AA-1 | Vinyl | GLM | AME-400 | 75 | 10 | 15 | 6800 |
| | polymer | | | acetate | | | | | | |
| Example | Branched | C-2 | AA-1 | Vinyl | GLM | AME-400 | 75 | 10 | 15 | 6800 |
| | polymer | | | acetate | | | | | | |
| Example | Branched | C-3 | AA-1 | Vinyl | GLM | AME-400 | 75 | 10 | 15 | 6800 |
| | polymer | | | acetate | | | | | | |
| Example | Branched | C-4 | AA-1 | Vinyl | GLM | AME-400 | 75 | 10 | 15 | 6800 |
| | polymer | | | acetate | | | | | | |
| Example | Branched | C-5 | AA-1 | Vinyl | GLM | AME-400 | 75 | 10 | 15 | 6800 |
| | polymer | | | acetate | | | | | | |
| Example | Branched | C-6 | AA-2 | Vinyl | GLM | AME-400 | 75 | 10 | 15 | 2200 |
| | polymer | | | acetate | | | | | | |
| Example | Branched | C-7 | AA-3 | Vinyl | GLM | AME-400 | 75 | 10 | 15 | 42000 |
| | polymer | | | acetate | | | | | | |
| Example | Branched | C-8 | AA-4 | Vinyl | GLM | AME-400 | 75 | 10 | 15 | 9800 |
| | polymer | | | acetate | | | | | | |
| Example | Branched | C-9 | AA-5 | C6FA | GLM | AME-400 | 60 | 10 | 30 | 3300 |
| | polymer | | | | | | | | | |
| Example | Branched | C-10 | AA-6 | C6FA | GLM | — | 60 | 40 | — | 4000 |
| | polymer | | | | | | | | | |
| Example | Branched | C-11 | AA-7 | Vinyl | GLM | C6FA | 70 | 10 | 20 | 9900 |
| | polymer | | | acetate | | | | | | |
| Example | Branched | C-12 | AA-8 | Vinyl | GLM | C6FA | 75 | 15 | 10 | 7100 |
| | polymer | | | acetate | | | | | | |
| Example | Branched | C-13 | AA-9 | Vinyl | KARENZ | AME-400 | 75 | 10 | 15 | 5800 |
| | polymer | | | acetate | AOI | | | | | |
| Comparative | Branched | Z-1 | AA-10 | t-Butyl | GLM | AME-400 | 75 | 10 | 15 | 9500 |
| Example | polymer | | | acrylate | | | | | | |
| Comparative | Branched | Z-2 | AA-1 | Vinyl | GLM | AME-400 | 75 | 10 | 15 | 6800 |
| Example | polymer | | | acetate | | | | | | |

| | Branch polymer | | | | | | | |
|---|---|---|---|---|---|---|---|---|
| | | | | Monomer | | | | Content |
| | | | | compositional | | | | ratio of |
| | | | | ratio | | | Mw of all | fluorine |
| | No. | Monomer composition | | (% by mass) | | Mw | polymers | (% by mass) |
| Example | BB-1 | C6FA | — | 100 | — | 2100 | 8300 | 10.67 |
| Example | BB-2 | C6FA | AME-400 | 80 | 20 | 1300 | 15600 | 26.65 |
| Example | BB-3 | C6FA | Methyl | 60 | 40 | 6500 | 29100 | 27.16 |
| | | | methacrylate | | | | | |
| Example | BB-1 | C6FA | — | 100 | — | 2100 | 12200 | 26.14 |
| Example | BB-1 | C6FA | — | 100 | — | 2100 | 9900 | 18.49 |
| Example | BB-1 | C6FA | — | 100 | — | 2100 | 7600 | 41.96 |
| Example | BB-1 | C6FA | — | 100 | — | 2100 | 51000 | 10.42 |
| Example | BB-1 | C6FA | — | 100 | — | 2100 | 13100 | 14.88 |
| Example | BB-4 | Vinyl | — | 100 | — | 12500 | 26000 | 4.50 |
| | | acetate | | | | | | |
| Example | BB-5 | Vinyl | — | 100 | — | 9800 | 12200 | 11.62 |
| | | acetate | | | | | | |
| Example | BB-6 | C6FA | Vinyl | 96 | 4 | 3600 | 15300 | 27.65 |
| | | | acetate | | | | | |
| Example | BB-7 | C6FA | Vinyl | 98 | 2 | 2200 | 17300 | 36.55 |
| | | | acetate | | | | | |
| Example | BB-8 | C6FA | — | 100 | — | 7200 | 14400 | 35.27 |
| Comparative | BB-1 | C6FA | — | 100 | — | 2100 | 10700 | 6.62 |
| Example | | | | | | | | |
| Comparative | BB-9 | HFP | — | 100 | — | 4800 | 16800 | 45.23 |
| Example | | | | | | | | |

C6FA: 2-(Perfluorohexyl)ethyl acrylate
AME-400: BLEMMER AME-400 (manufactured by NOF Corporation)
GLM: Glycidyl methacrylate
KARENZ AOI (registered trademark): 2-Acryloyloxyethyl isocyanate (manufactured by Showa Denko K.K.)
HFP: Hexafluoropropylene

### Synthesis of Block Copolymer

Vinyl acetate (10 g, 116.2 millimoles), S,S-dibenzyltrithiocarbonate (0.1 g), “V-601” (manufactured by Pure Wako Chemical Industries, Ltd.) (0.05 g), and methyl ethyl ketone (20 g) were added to a 200-milliliter three-neck flask equipped with a stirrer, a thermometer, a reflux cooling pipe, an oil bath, and a nitrogen gas introduction pipe and reacted together at 60° C. for six hours. After the end of the reaction, the components were purified by being reprecipitated in methanol, and the obtained polymer (polymer in the first stage) was dissolved in methyl ethyl ketone (20 g). The weight-average molecular weight of the polymer in the first stage was 4,800. Next, 2-(perfluorohexyl)ethyl acrylate (10 g, 23.9 millimoles) and “V-601” (0.05 g) were added to a methyl ethyl ketone solution of the polymer in the first stage and were reacted together at 60° C. for six hours, thereby obtaining a block copolymer in which a polymer in the second stage was coupled to the polymer in the first stage. The obtained solution was reprecipitated in methanol, thereby obtaining a block copolymer D-1 (42 g) which is the fluorine-containing copolymer of the present invention. The weight-average molecular weight of this block copolymer D-1 was 9,100, and the weight-average molecular weight of the polymer in the second stage was computed to be 4,300.

Block copolymers D-2 to D-10, Z-3, and Z-4 were synthesized in the same manner except for the fact that the kind and weight-average molecular weight of the monomer were changed to the contents shown in Table 4. D-4 is a block copolymer in which the monomer described in Table 4 was reacted with a methyl ethyl ketone solution of the polymer in the second stage, thereby further coupling a polymer in the third stage. Numerical values in the column “monomer compositional ratio” in Table 4 respectively correspond to monomers sequentially described in the column “monomer composition” from the left. “Mw's” in Table 4 respectively represents the weight-average molecular weight of the polymer in the first stage, the weight-average molecular weight of the polymer in the second stage, and the weight-average molecular weight of the polymer in the third stage. Regarding these weight-average molecular weights, for example, in the case of a diblock copolymer, the weight-average molecular weight of the polymer in the second stage was computed by subtracting the weight-average molecular weight of the polymer in the first stage from the weight-average molecular weight of the finally-obtained polymer.

TABLE 4

| | | | Polymer in first stage | | | | | | |
|---|---|---|---|---|---|---|---|---|---|
| | | | | | Monomer | | | | |
| | | | | | compositional | | | | |
| | Shape of | | | | ratio | | | Polymer in second stage | |
| | polymer | No. | Monomer composition | | (% by mass) | | Mw | Monomer composition | |
| Example | Block | D-1 | Vinyl | — | 100 | — | 4800 | C6FA | — |
| | copolymer | | acetate | | | | | | |
| Example | Block | D-2 | Vinyl | AME-400 | 70 | 30 | 4500 | C6FA | Stearyl |
| | copolymer | | acetate | | | | | | methacrylate |
| Example | Block | D-3 | Vinyl | AE-200 | 50 | 50 | 18200 | FAAC-4 | Benzyl |
| | copolymer | | acetate | | | | | | methacrylate |
| Example | Block | D-4 | C6FA | — | 100 | — | 2800 | Vinyl | — |
| | copolymer | | | | | | | acetate | |
| Example | Block | D-5 | Vinyl | — | 100 | — | 1200 | C6FA | — |
| | copolymer | | acetate | | | | | | |
| Example | Block | D-6 | Vinyl | — | 100 | — | 6200 | C6FA | — |
| | copolymer | | acetate | | | | | | |
| Example | Block | D-7 | Vinyl | C6FA | 80 | 20 | 7500 | AME-400 | C6FA |
| | copolymer | | acetate | | | | | | |
| Example | Block | D-8 | Vinyl | C6FA | 90 | 10 | 10900 | AME-400 | C6FA |
| | copolymer | | acetate | | | | | | |
| Example | Block | D-9 | Vinyl | 2-Hydroxyethyl | 30 | 70 | 8400 | C6FA | Butyl |
| | copolymer | | acetate | acrylate | | | | | acrylate |
| Example | Block | D-10 | Vinyl | — | 100 | — | 5500 | C6FA | — |
| | copolymer | | laurate | | | | | | |
| Comparative | Block | Z-3 | t-Butyl | PME-1000 | 80 | 20 | 6000 | C6FA | — |
| Example | copolymer | | acrylate | | | | | | |
| Comparative | Block | Z-4 | Vinyl | — | 100 | — | 5400 | HFP | — |
| Example | copolymer | | acetate | | | | | | |

| | Polymer in second stage | | | Polymer in third stage | | | |
|---|---|---|---|---|---|---|---|
| | Monomer | | | | Monomer | | Content |
| | compositional | | | | compositional | | ratio of |
| | ratio | | | Monomer | ratio | | fluorine |
| | (% by mass) | | Mw | composition | (% by mass) | Mw | (% by mass) |
| Example | 100 | — | 4300 | — | — | — | 27.91 |
| Example | 60 | 40 | 2800 | — | — | — | 13.59 |
| Example | 30 | 70 | 2500 | — | — | — | 1.95 |
| Example | 100 | — | 2000 | AME-400 | 100 | 500 | 31.20 |
| Example | 100 | — | 16000 | — | — | — | 54.94 |
| Example | 100 | — | 1600 | — | — | — | 12.11 |
| Example | 60 | 40 | 2400 | — | — | — | 9.01 |
| Example | 50 | 50 | 800 | — | — | — | 5.52 |
| Example | 50 | 50 | 4900 | — | — | — | 10.88 |
| Example | 100 | — | 1600 | — | — | — | 13.31 |
| Comparative | 100 | — | 1100 | — | — | — | 9.15 |
| Example | | | | | | | |
| Comparative | 100 | — | 4300 | — | — | — | 33.68 |
| Example | | | | | | | |

AE-200: BLEMMER AE-200 (manufactured by NOF Corporation)
PME-1000: BLEMMER PME-1000 (manufactured by NOF Corporation)
FAAC-4: CHEMINOX FAAC-4 (manufactured by Unimatec Corporation)

### Synthesis of Branched Polymer

### Synthesis of Branch Polymer

Methyl ethyl ketone (10.0 g) was prepared in a 200-milliliter three-neck flask equipped with a stirrer, a thermometer, a reflux cooling pipe, an oil bath, and a nitrogen gas introduction pipe and heated up to 78° C. Next, a mixed solution made up of vinyl acetate (20 g, 230.1 millimoles), 3-mercaptopropionic acid (2.4 g, 23.0 millimoles), methyl ethyl ketone (10.0 g), and “V-501” (manufactured by Pure Wako Chemical Industries, Ltd.) (0.13 g) was added dropwise at a constant rate so that the dropwise addition was completed in 180 minutes. After the completion of the dropwise addition, the mixed solution was further continuously stirred for five hours, thereby obtaining a methyl ethyl ketone solution (40.0 g) of a branch polymer E-1. The weight-average molecular weight (Mw) of this polymer was 2,200.

Branch polymers E-2 to E-7 and F-1 to F-6 were synthesized in the same manner except for the fact that the kind of the monomer was changed to the contents shown in Table 5.

### Synthesis of Branched Polymer

The branch polymer E-1 (10.0 g) as a branch polymer (1), the branch polymer F-1 (10.0 g) as a branch polymer (2), and polyethyleneimine (weight-average molecular weight: 600) (0.3 g) as a compound forming the central point were added to a 200-milliliter three-neck flask equipped with a stirrer, a thermometer, a reflux cooling pipe, and an oil bath and heated at 78° C. for five hours. The obtained solution was reprecipitated in methanol, thereby obtaining a branched polymer G-1 (16.7 g) which is the fluorine-containing copolymer of the present invention. The weight-average molecular weight (Mw) of this polymer was 9,500.

Branched polymers G-2 to G-12, Z-5, and Z-6 were synthesized in the same manner except for the fact that the kinds and preparation ratios of the branch polymer (1), the branch polymer (2), and the compound forming the central point were changed to the contents shown in Table 5.

TABLE 5

| | | | Branch polymer | | | | | | | | |
|---|---|---|---|---|---|---|---|---|---|---|---|
| | | | (1) | | | | | | | | |
| | | | | | | Monomer | | | | | |
| | | | | | | compositional | | | Branch polymer | | |
| | Shape of | | | | | ratio | | | (2) | | |
| | polymer | No. | No. | Monomer composition | | (% by mass) | | Mw | No. | Monomer composition | |
| Example | Branched | G-1 | E-1 | Vinyl | — | 100 | — | 2200 | F-1 | C6FA | — |
| | polymer | | | acetate | | | | | | | |
| Example | Branched | G-2 | E-1 | Vinyl | — | 100 | — | 2200 | F-1 | C6FA | — |
| | polymer | | | acetate | | | | | | | |
| Example | Branched | G-3 | E-1 | Vinyl | — | 100 | — | 2200 | F-1 | C6FA | — |
| | polymer | | | acetate | | | | | | | |
| Example | Branched | G-4 | E-1 | Vinyl | — | 100 | — | 2200 | F-1 | C6FA | — |
| | polymer | | | acetate | | | | | | | |
| Example | Branched | G-5 | E-1 | Vinyl | — | 100 | — | 2200 | F-1 | C6FA | — |
| | polymer | | | acetate | | | | | | | |
| Example | Branched | G-6 | E-2 | Vinyl | C6FA | 80 | 20 | 3600 | F-2 | AME-400 | C6FA |
| | polymer | | | acetate | | | | | | | |
| Example | Branched | G-7 | E-3 | Vinyl | C6FA | 90 | 10 | 3300 | F-2 | AME-400 | C6FA |
| | polymer | | | acetate | | | | | | | |
| Example | Branched | G-8 | E-4 | Vinyl | AME-400 | 70 | 30 | 1600 | F-3 | C6FA | — |
| | polymer | | | acetate | | | | | | | |
| Example | Branched | G-9 | E-5 | Vinyl | AME-400 | 70 | 30 | 18000 | F-4 | C6FA | — |
| | polymer | | | acetate | | | | | | | |
| Example | Branched | G-10 | E-1 | Vinyl | — | 100 | — | 2200 | F-1 | C6FA | — |
| | polymer | | | acetate | | | | | | | |
| Example | Branched | G-11 | E-1 | Vinyl | — | 100 | — | 2200 | F-1 | C6FA | — |
| | polymer | | | acetate | | | | | | | |
| Example | Branched | G-12 | E-6 | Vinyl | BLEMMER E | 50 | 50 | 4400 | F-5 | FAMAC-6 | — |
| | polymer | | | acetate | | | | | | | |
| Comparative | Branched | Z-5 | E-7 | t-Butyl | EMA | 50 | 50 | 3600 | F-1 | C6FA | — |
| Example | polymer | | | acrylate | | | | | | | |
| Comparative | Branched | Z-6 | E-1 | Vinyl | — | 100 | — | 2200 | F-6 | HFP | — |
| Example | polymer | | | acetate | | | | | | | |

| | Branch polymer | | | | | | | | | |
|---|---|---|---|---|---|---|---|---|---|---|
| | (2) | | | | | Preparation ratio | | | | |
| | Monomer | | | | | (% by mass) | | | | Content |
| | compositional | | | Compound forming central | | Branch | Branch | | | ratio of |
| | ratio | | | point | | polymer | polymer | Central | Mw of all | fluorine |
| | (% by mass) | | Mw | Kind | Mw | (1) | (2) | point | polymers | (% by mass) |
| Example | 100 | — | 1800 | Polyethyl- | 600 | 45 | 40 | 15 | 9500 | 23.62 |
| | | | | eneimine | | | | | | |
| Example | 100 | — | 1800 | Polyethyl- | 600 | 65 | 30 | 5 | 7200 | 17.72 |
| | | | | eneimine | | | | | | |
| Example | 100 | — | 1800 | Polyethyl- | 600 | 50 | 20 | 30 | 8800 | 11.81 |
| | | | | eneimine | | | | | | |
| Example | 100 | — | 1800 | Polyethyl- | 1800 | 45 | 40 | 15 | 10100 | 23.62 |
| | | | | eneimine | | | | | | |
| Example | 100 | — | 1800 | Polyethyl- | 10000 | 45 | 40 | 15 | 16600 | 23.62 |
| | | | | eneimine | | | | | | |
| Example | 30 | 70 | 4500 | Polyethyl- | 600 | 45 | 40 | 15 | 9400 | 21.85 |
| | | | | eneimine | | | | | | |
| Example | 30 | 70 | 4500 | Polyethyl- | 600 | 45 | 40 | 15 | 14200 | 19.19 |
| | | | | eneimine | | | | | | |
| Example | 100 | — | 1300 | Polyethyl- | 600 | 45 | 40 | 15 | 5100 | 23.62 |
| | | | | eneimine | | | | | | |
| Example | 100 | — | 17600 | Polyethyl- | 600 | 45 | 40 | 15 | 28600 | 23.62 |
| | | | | eneimine | | | | | | |
| Example | 100 | — | 1800 | Polyethyl- | 300 | 45 | 40 | 15 | 6200 | 23.62 |
| | | | | eneimine | | | | | | |
| Example | 100 | — | 1800 | MARPROOF | 10000 | 45 | 40 | 15 | 15800 | 23.62 |
| | | | | G-0150M | | | | | | |
| Example | 100 | — | 2900 | Polyethyl- | 600 | 45 | 40 | 15 | 7700 | 22.86 |
| | | | | eneimine | | | | | | |
| Comparative | 100 | — | 1800 | Polyethyl- | 600 | 45 | 40 | 15 | 6800 | 23.62 |
| Example | | | | eneimine | | | | | | |
| Comparative | 100 | — | 2500 | Polyethyl- | 600 | 45 | 40 | 15 | 10600 | 30.39 |
| Example | | | | eneimine | | | | | | |

BLEMMER E: BLEMMER E (manufactured by NOF Corporation)
EMA: Ethyl methacrylate
FAMAC-6: CHEMINOX FAMAC-6 (manufactured by Unimatec Corporation)
MARPROOF G-0150M: MARPROOF G-0150M (manufactured by NOF Corporation, epoxy group-containing acrylic polymer)

### Preparation of Composition (Coating Solution) For Forming Hardcoat Layer

Individual components were mixed together so as to obtain the following composition, and the solid content concentration was caused to reach approximately 55% by mass, thereby preparing a composition for forming a hardcoat layer HC-1.

(Composition of hardcoat layer coating solution HC-1)

| | |
|---|---|
| Dipenthaerythiritol hexaacrylate (DPHA): | 29.7 parts by mass |
| KAYARD DPHA (manufactured by Nippon | |
| Kayaku Co., Ltd.) (hexafunctional) | |
| IRGACURE 184: Alkylphenone-based photo- | 2.20 parts by mass |
| polymerization initiator (manufactured | |
| by BASF) | |
| 3,4-Epoxycyclohexylmethyl methacrylate: | 13.8 parts by mass |
| CYCLOMER M100 (Daicel Corporation, | |
| molecular weight: 196) | |
| Compound 1 | 0.55 parts by mass |
| Fluorine-containing copolymer C-1 | 0.02 parts by mass |
| ELECOM V-8802: MiBK dispersion liquid of a | 8.25 parts by mass |
| solid content of 40% by mass of polymerizable | |
| group-attached spherical silica fine particles | |
| having an average particle diameter of 12 nm | |
| (manufactured by JGC Corporation) | |
| Tinuvin928: Benzotriazole-based ultraviolet | 0.55 parts by mass |
| absorbsent (manufactured by BASF) | |
| MEK: Methyl ethyl ketone | 22.5 parts by mass |
| MiBK: Methyl isobutyl ketone | 13.5 parts by mass |
| Methyl acetate: | 9.0 parts by mass |

Compound 1 is the same as the above-described compound.

### Preparation of Compositions For Forming Hardcoat Layer HC-2 to HC-42

Compositions for forming a hardcoat layer HC-2 to HC-42 were produced in the same manner as described above except for the fact that the fluorine-containing copolymer C-1 was changed to the fluorine-containing copolymers in Table 6.

### Provision of Hardcoat Layer by Means of Coating

TJ25 (manufactured by Fujifilm Corporation) which was a support unwound in a roll form and the compositions for forming a hardcoat layer HC-1 to HC-42 were used, thereby producing hardcoat films T-1 to T-42.

Specifically, each of the compositions for forming a hardcoat layer was applied onto the support under a condition of a transportation rate of 30 m/minute using a die coating method in which the slot die described in Example 1 of JP2006-122889A was used, dried at 60° C. for 150 seconds, then, furthermore, irradiated with ultraviolet rays at an illuminance of 400 mW/cm² and an irradiance level of 500 mJ/cm² using a 160 W/cm air-cooling metal halide lamp (manufactured by Eye Graphics Co., Ltd.) under nitrogen purging at an oxygen concentration of approximately 0.1% by volume so as to cure the coated layer, whereby a hardcoat layer was formed and then wound.

The produced hardcoat films T-1 to T-42 were evaluated using the following evaluation method.

### Film Thickness of Hardcoat Layer

The film thickness of the hardcoat layer was computed using the same method as described above. The film thickness of the hardcoat layer was 6.0 μm in all of the hardcoat films T-1 to T-42.

### Surface Property Uniformity of Hardcoat Layer

In order to prevent reflection on a surface (rear surface) of the hardcoat film opposite to the hardcoat layer, the rear surface was fully covered with a black marker, and then the front surface (the hardcoat layer-coated surface) of the hardcoat film was observed under a three-wavelength fluorescent lamp having a diffusion plate attached to the front surface. The hardcoat film was visually observed from the front surface and evaluated using the following evaluation standards.

Evaluation rankings of A to C in the following evaluation standards were considered as a pass.

A: There were no interference fringes

B: An extremely small number of interference fringes were observed, but the interference fringes were on a concerning level.

C: A small number of interference fringes were observed, but remained in a permissible range as products.

D: Interference fringes were observed here and on a concerning level.

E: A large number of interference fringes were generated.

F: Interference fringes were strongly generated.

### Saponification of Hardcoat Film

The produced hardcoat films were saponified using the same method as described above.

### Contact Angle of water

A 3 μL liquid droplet was produced in a dried state (20° C./relative humidity: 65%) at a needle tip using a contact angle meter [“CA-X”-type contact angle meter, manufactured by Kyowa Interface Science Co., Ltd,] and pure water as liquid and brought into contact with the surface of the hardcoat layer in the saponified hardcoat film, thereby producing a liquid droplet on the film. The angle on a side including the liquid was measured from the angle formed by a normal line to the liquid surface and the film surface at a point at which the film and the liquid came into contact with each other in ten seconds after the dropwise addition and considered as the contact angle. The contact angle was evaluated on the basis of the results using the following standards.

A: The contact angle was 50° or less.

B: The contact angle was more than 50° and 55° or less.

C: The contact angle was more than 55° and 65° or less.

D: The contact angle was more than 65° and 70° or less.

E: The contact angle was more than 70° and 75° or less.

F: The contact angle was more than 75°.

TABLE 6

| | | | | | | Evaluation | |
|---|---|---|---|---|---|---|---|
| | | Composition | Fluorine- | | Film thickness of | Surface property | Contact angle |
| | Hardcoat | for forming | containing | | hardcoat layer | uniformity of | of water alter |
| | film | hardcoat layer | copolymer | Support | (μm) | hardcoat layer | saponification |
| Example | T-1 | HC-1 | C-1 | TJ25 | 6.0 | A | A |
| Example | T-2 | HC-2 | C-2 | TJ25 | 6.0 | A | A |
| Example | T-3 | HC-3 | C-3 | TJ25 | 6.0 | A | A |
| Example | T-4 | HC-4 | C-4 | TJ25 | 6.0 | B | A |
| Example | T-5 | HC-5 | C-5 | TJ25 | 6.0 | A | B |
| Example | T-6 | HC-6 | C-6 | TJ25 | 6.0 | B | A |
| Example | T-7 | HC-7 | C-7 | TJ25 | 6.0 | A | B |
| Example | T-8 | HC-8 | C-8 | TJ25 | 6.0 | A | C |
| Example | T-9 | HC-9 | C-9 | TJ25 | 6.0 | A | A |
| Example | T-10 | HC-10 | C-10 | TJ25 | 6.0 | A | A |
| Example | T-11 | HC-11 | C-11 | TJ25 | 6.0 | B | C |
| Example | T-12 | HC-12 | C-12 | TJ25 | 6.0 | B | B |
| Example | T-13 | HC-13 | D-1 | TJ25 | 6.0 | A | A |
| Example | T-14 | HC-14 | D-2 | TJ25 | 6.0 | A | A |
| Example | T-15 | HC-15 | D-3 | TJ25 | 6.0 | A | A |
| Example | T-16 | HC-16 | D-4 | TJ25 | 6.0 | A | A |
| Example | T-17 | HC-17 | D-5 | TJ25 | 6.0 | A | C |
| Example | T-18 | HC-18 | D-6 | TJ25 | 6.0 | C | B |
| Example | T-19 | HC-19 | D-7 | TJ25 | 6.0 | C | C |
| Example | T-20 | HC-20 | D-8 | TJ25 | 6.0 | B | C |
| Example | T-21 | HC-21 | D-9 | TJ25 | 6.0 | B | B |
| Example | T-22 | HC-22 | D-10 | TJ25 | 6.0 | A | C |
| Example | T-23 | HC-23 | G-1 | TJ25 | 6.0 | A | A |
| Example | T-24 | HC-24 | G-2 | TJ25 | 6.0 | A | A |
| Example | T-25 | HC-25 | G-3 | TJ25 | 6.0 | B | A |
| Example | T-26 | HC-26 | G-4 | TJ25 | 6.0 | B | B |
| Example | T-27 | HC-27 | G-5 | TJ25 | 6.0 | C | B |
| Example | T-28 | HC-28 | G-6 | TJ25 | 6.0 | C | C |
| Example | T-29 | HC-29 | G-7 | TJ25 | 6.0 | B | C |
| Example | T-30 | HC-30 | G-8 | TJ25 | 6.0 | B | A |
| Example | T-31 | HC-31 | G-9 | TJ25 | 6.0 | A | B |
| Example | T-32 | HC-32 | G-10 | TJ25 | 6.0 | B | B |
| Example | T-33 | HC-33 | G-11 | TJ25 | 6.0 | B | C |
| Example | T-34 | HC-34 | G-12 | TJ25 | 6.0 | A | B |
| Example | T-35 | HC-35 | B-1 | TJ25 | 6.0 | C | C |
| Comparative | T-36 | HC-36 | Z-1 | TJ25 | 6.0 | B | F |
| Example | | | | | | | |
| Comparative | T-37 | HC-37 | Z-2 | TJ25 | 6.0 | E | B |
| Example | | | | | | | |
| Comparative | T-38 | HC-38 | Z-3 | TJ25 | 6.0 | B | F |
| Example | | | | | | | |
| Comparative | T-39 | HC-39 | Z-4 | TJ25 | 6.0 | E | B |
| Example | | | | | | | |
| Comparative | T-40 | HC-40 | Z-5 | TJ25 | 6.0 | B | F |
| Example | | | | | | | |
| Comparative | T-41 | HC-41 | Z-6 | TJ25 | 6.0 | E | B |
| Example | | | | | | | |
| Example | T-42 | HC-42 | C-13 | TJ25 | 6.0 | B | C |

According to the present invention, it is possible to provide a fluorine-containing copolymer capable of forming films that are excellent in terms of surface properties and a lamination property with other layers, a composition containing the fluorine-containing copolymer, an optical film having a layer formed of the composition, a hardcoat film, a polarizing plate, and a touch panel display, and a method for producing a fluorine-containing copolymer.

The present invention has been described in detail, also, with reference to specific embodiments, but it is clear to persons skilled in the art that the present invention can be modified or corrected in a variety of manners within the spirit and scope of the present invention.

What is claimed is:

1. A fluorine-containing copolymer comprising:
a repeating unit represented by General Formula (I); and
a repeating unit represented by General Formula (II), 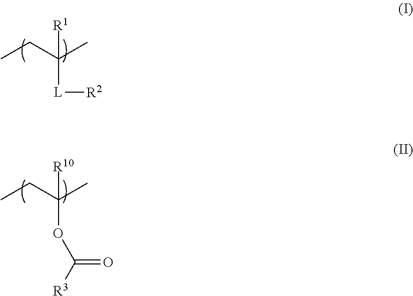
in General Formulae (I) and (II), R¹, R¹⁰, and R³ each independently represent a hydrogen atom or an alkyl group having 1 to 20 carbon atoms, R² represents an alkyl group having 1 to 20 carbon atoms in which at least one carbon atom has a fluorine atom as a substituent, and L represents a divalent linking group constituted of at least one group selected from the group consisting of —O—, —(C═O)O—, —O(C═O)—, divalent chain-like groups, and divalent aliphatic cyclic groups.

2. The fluorine-containing copolymer according to claim 1,
wherein the fluorine-containing copolymer has at least a first segment and a second segment,
the first segment includes 30% by mass or more of the repeating unit represented by General Formula (I) and includes 0% to 20% by mass of the repeating unit represented by General Formula (II) with respect to all repeating units included in the first segment, and
the second segment includes 30% by mass or more of the repeating unit represented by General Formula (II) and includes 0% to 3% by mass of the repeating unit represented by General Formula (I) with respect to all repeating units included in the second segment.

3. The fluorine-containing copolymer according to claim 2,
wherein the fluorine-containing copolymer is a polymer or a block copolymer having a branched structure.

4. The fluorine-containing copolymer according to claim 1,
wherein the repeating unit represented by General Formula (I) is represented by General Formula (III), 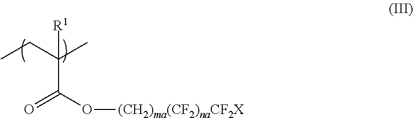
in General Formula (III), R¹ represents a hydrogen atom or an alkyl group having 1 to 20 carbon atoms, ma and na each independently represent an integer of 1 to 10, and X represents a hydrogen atom or a fluorine atom.

5. The fluorine-containing copolymer according to claim 4,
wherein ma represents 1 or 2, and na represents an integer of 1 to 6.

6. The fluorine-containing copolymer according to claim 1,
wherein R³ is a methyl group, an ethyl group, a propyl group, a t-butyl group, or an n-butyl group.

7. The fluorine-containing copolymer according to claim 1, further comprising:
a repeating unit represented by General Formula (IV), 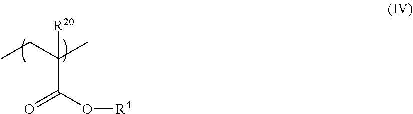
in General Formula (IV), R²⁰ represents a hydrogen atom or an alkyl group having 1 to 20 carbon atoms, and R⁴ represents a chain-like or cyclic alkyl group, an alkenyl group, or a polyoxyalkylene group which may have a substituent.

8. The fluorine-containing copolymer according to claim 7,
wherein the repeating unit represented by General Formula (IV) is represented by General Formula (V), 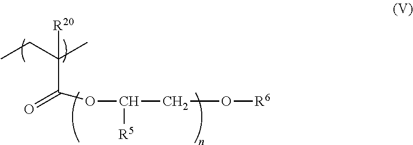
in General Formula (V), R²⁰ represents a hydrogen atom or an alkyl group having 1 to 20 carbon atoms, R⁵ and R⁶ each independently represent a hydrogen atom or a methyl group, and n represents an integer of 1 to 100.

9. A composition comprising:
the fluorine-containing copolymer according to claim 1.

10. The composition according to claim 9, further comprising:
a curable compound.

11. An optical film comprising:
a layer formed of the composition according to claim 9.

12. A hardcoat film comprising:
a layer formed of the composition according to claim 9.

13. A polarizing plate comprising:
a layer formed of the composition according to claim 9.

14. A touch panel display comprising:
a liquid crystal cell;
the polarizing plate according to claim 13 on a viewer side of the liquid crystal cell; and
OCA or OCR on a surface of the polarizing plate opposite to the liquid crystal cell.

15. A method for producing a fluorine-containing copolymer having at least a first segment and a second segment, the first segment including 30% by mass or more of a repeating unit represented by General Formula (I) and including 0% to 20% by mass of a repeating unit represented by General Formula (II) with respect to all repeating units included in the first segment, and the second segment including 30% by mass or more of the repeating unit represented by General Formula (II) and including 0% to 3% by mass of the repeating unit represented by General Formula (I) with respect to all repeating units included in the second segment, the method comprising any one of following steps (i) to (iii):
(i): a step of respectively synthesizing a first polymer including 30% by mass or more of the repeating unit represented by General Formula (I) and a second polymer including 30% by mass or more of the repeating unit represented by General Formula (II) and subsequently bonding the first polymer and the second polymer;
(ii): a step of synthesizing the first polymer including 30% by mass or more of the repeating unit represented by General Formula (I) and subsequently reacting a compound represented by General Formula (II-M) with the first polymer; and
(iii): a step of synthesizing the second polymer including 30% by mass or more of the repeating unit represented by General Formula (II) and subsequently reacting a compound represented by General Formula (I-M) with the second polymer, 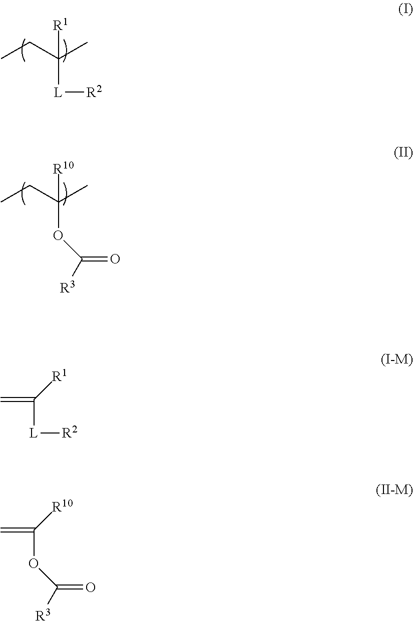
in General Formulae (I), (II), (I-M), and (II-M), R¹, R¹⁰, and R³ each independently represent a hydrogen atom or an alkyl group having 1 to 20 carbon atoms, R² represents an alkyl group having 1 to 20 carbon atoms in which at least one carbon atom has a fluorine atom as a substituent, and L represents a divalent linking group constituted of at least one group selected from the group consisting of —O—, —(C═O)O—, —O(C═O)—, divalent chain-like groups, and divalent aliphatic cyclic groups.
